(19) United States
(12) Patent Application Publication
(10) Pub. No.: US 2015/0142897 A1
(43) Pub. Date: May 21, 2015

(54) MANAGING TEXT MESSAGES

(71) Applicant: Dropbox, Inc., San Francisco, CA (US)

(72) Inventors: Brett Alten, Cupertino, CA (US); Adam Cue, San Francisco, CA (US)

(73) Assignee: Dropbox, Inc., San Francisco, CA (US)

(21) Appl. No.: 14/083,357

(22) Filed: Nov. 18, 2013

(51) Int. Cl. H04L 12/58

(52) U.S. Cl. CPC H04L 51/36
USPC 709/206

(57) ABSTRACT

Message management services for text messages can include converting, modifying, or copying a text message so as to create an email that a corresponds to the text message; adding a subject line to a corresponding email to facilitate grouping, threading, and searching; linking a corresponding email to the original text message to enable a text-message reply to a corresponding email; email-address-lookup services to enable an email reply to a corresponding email; and so on.

### BACKGROUND

This relates generally to management services for text messages and in particular to using email for managing text messages.

A “text message” as used herein refers to a brief, electronic message sent between two or more computing devices. Text messages are commonly transmitted over mobile networks between mobile-network-connected devices, such as mobile phones. Such text messages are commonly sent using SMS (Short Message Service), and are therefore sometimes referred to as SMS messages. Such text messages are also sent using MMS (Multimedia Message Service). These text messages are sometimes referred to as MMS messages and can include multimedia content, such as music, photos, and video. Internet-connected devices, such as desktop, laptop, wearable, and tablet computers, can also be used to send and receive text messages, including SMS and MMS messages. Text messages, as used herein, also includes messages sent between users of instant message services (e.g., iMessage®, Yahoo! Messenger®, Windows Live Messenger®, AIM®), social networking services (e.g., Facebook®, Google+®, LinkedIn®), microblogs (e.g., Twitter®, Tumblr®), and other communication services.

### SUMMARY

Many users receive a large number of text messages throughout a day. Once a text message is read, it can be automatically marked ‘read’ and the user cannot mark it ‘unread’ or otherwise flag it as requiring a response. If the user is unable to respond immediately, other text messages received later in the day can bury it. This can result in the user forgetting to respond. Further, unlike email, text messages do not persist on the message providers' servers. Instead, message service providers only save text messages as long as is necessary to deliver them. Accordingly, for example, a user who loses his mobile phone has no way to recover the text messages saved on the phone. Additionally, some text messages may require a lengthy and/or formatted response that would be easier to compose using email. “Email” as used herein can refer to an electronic message or a system for sending such electronic message.

Certain embodiments of the invention relate to providing message management services for text messages. In various embodiments, the services can include converting, copying, or modifying a text message (referred to herein as an “original” text message) to email by creating an email that corresponds to the text message (referred to herein as a “corresponding” email); adding a subject line to a corresponding email to facilitate grouping, threading, and searching; linking a corresponding email to the original text message to enable a text-message reply to a corresponding email; email-address-lookup services to enable an email reply to a corresponding email; and so on.

Certain embodiments relate to a method that can include obtaining, by a device, a create email input associated with a text message displayed by the device, the text message including a sender identifier and text message data. Responsive to detecting the create email gesture, some embodiments of the method can also include creating, by the device, a corresponding email for the text message, where creating the corresponding email can include: including at least a portion of the text message data in a body of the corresponding email; and including the sender identifier in at least one of the body and a header of the corresponding email. Responsive to an instruction to reply to the corresponding email, some embodiments of the method can further include displaying, by the device, at least one of an option to reply by text message and an option to reply by email.

Certain embodiments relate to a device that can include a user interface, a processor, and a memory device that stores instructions. When executed by the processor, the instructions can cause the processor to, at least: display via the user interface a text message having a sender identifier and a text message body; detect a create-email input that is input at the user interface and that is associated with the text message; and to create a corresponding email having an email body that includes the text-message body and a sender field that includes the sender identifier. Responsive to an instruction to reply to the corresponding email, the instruction can further cause the processor to display via the user interface at least one of an option to reply by text message and an option to reply by email.

Certain embodiments relate to a method that can include detecting, by a device, a create email input associated with a text message located on the device, where the text message can include a sender identifier and text message data. In some embodiments, responsive to detecting the create email gesture, the method can further include prompting, by a device, a user to input a subject to be included in a corresponding email, and creating, by the device, the corresponding email. The device, in some embodiments, can create the corresponding email by: including the subject in a subject of the corresponding email; including at least a portion of the text message data in a body of the corresponding email; and including the sender identifier in at least one of the subject, the body, and a sender field of the corresponding text message. The method, in some embodiments, can further include causing an email app on the device to display the corresponding email in an email inbox.

Certain embodiments relate to a computer readable storage medium that can have stored thereon executable instructions that, when executed by one or more processors of a computer system, can cause the computer system to execute a method that can include selecting a text message to be archived. In some embodiments, the text message can be selected based on at least on one of subject matter of text message data included in the text message and sender information included in the text message. In some embodiments, the method can also include sending to a message management service an archive instruction and at least a portion of the text message data and the sender information, where the archive instruction can cause the message management service to use at least a portion of the text message data and the sender information to create a corresponding email for the text message, and to archive the corresponding email on an archive data store.

While some embodiments can include message management services that can manage text messages by converting, copying, or modifying text messages to emails, one skilled in the art will recognize that numerous modifications are possible. For example, embodiments can be capable of managing a message received in any unmanaged data format and/or from any unmanaged communication channel (referred to herein as “an unmanaged message”). An unmanaged message can be an instant message, a message associated with networking service and/or microblog, a text message, as well as any other type of message received in any unmanaged data format and/or from any unmanaged communication channel. In some embodiments, an unmanaged message can be managed by converting, copying, or modifying the unmanaged massage to any type of managed data format.

The following detailed description together with the accompanying drawings will provide a better understanding of the nature and advantages of the present invention.

### BRIEF DESCRIPTION OF THE DRAWINGS

FIG. 1 shows a client provided in communication with message providers and a message management service in accordance with an embodiment of the present invention.

FIG. 2 shows a simplified block diagram illustrating a representative client device in accordance with an embodiment of the present invention.

FIG. 3 shows a schematic representation of a message management service in accordance with an embodiment of the present invention.

FIG. 4 shows an example interface related to creating a corresponding email in accordance with an embodiment of the present invention.

FIG. 5 shows an example interface related to creating a corresponding email in accordance with an embodiment of the present invention.

FIG. 6 shows an example interface related to creating a corresponding email in accordance with an embodiment of the present invention.

FIG. 7 shows a flow diagram of a process for creating a corresponding email in accordance with an embodiment of the present invention.

FIG. 8 shows an example interface related to replying to a corresponding email in accordance with an embodiment of the present invention.

FIG. 9 shows an example interface related to replying to a corresponding email in accordance with an embodiment of the present invention.

FIG. 10 shows an example interface related to replying to a corresponding email in accordance with an embodiment of the present invention.

FIG. 11 shows an example interface related to replying to a corresponding email in accordance with an embodiment of the present invention.

FIG. 12 shows an example interface related to replying to a corresponding email in accordance with an embodiment of the present invention.

FIG. 13 shows an example interface related to replying to a corresponding email in accordance with an embodiment of the present invention.

FIG. 14 shows a flow diagram of a process for replying to a corresponding email in accordance with an embodiment of the present invention.

FIG. 15 shows a flow diagram of a process for archiving text messages in accordance with an embodiment of the present invention.

FIG. 16 shows an example interface related to archiving text messages in accordance with an embodiment of the present invention.

FIG. 17 shows a user interface related to prioritization of emails in accordance with an embodiment of the present invention.

FIG. 18 shows a user interface related to grouping into conversations text messages that have corresponding emails in accordance with an embodiment of the present invention.

FIG. 19 shows a flow diagram of a process for converting, copying, or modifying unmanaged data into a managed data format according to embodiments of the present invention.

FIG. 20 shows a simplified block diagram illustrating a representative server system.

### DETAILED DESCRIPTION

Certain embodiments of the present invention relate to providing message management services for text messages. In various embodiments, a service can include any or all of converting, copying, or modifying a text message (referred to herein as “original” text message) so as to create an email that corresponds to the text message (referred to herein as “corresponding” email); adding a subject line to a corresponding email to facilitate grouping, threading, and searching; linking a corresponding email to the original text message to enable a text-message reply to a corresponding email; email-address-lookup services to enable an email reply to a corresponding email; and so on.

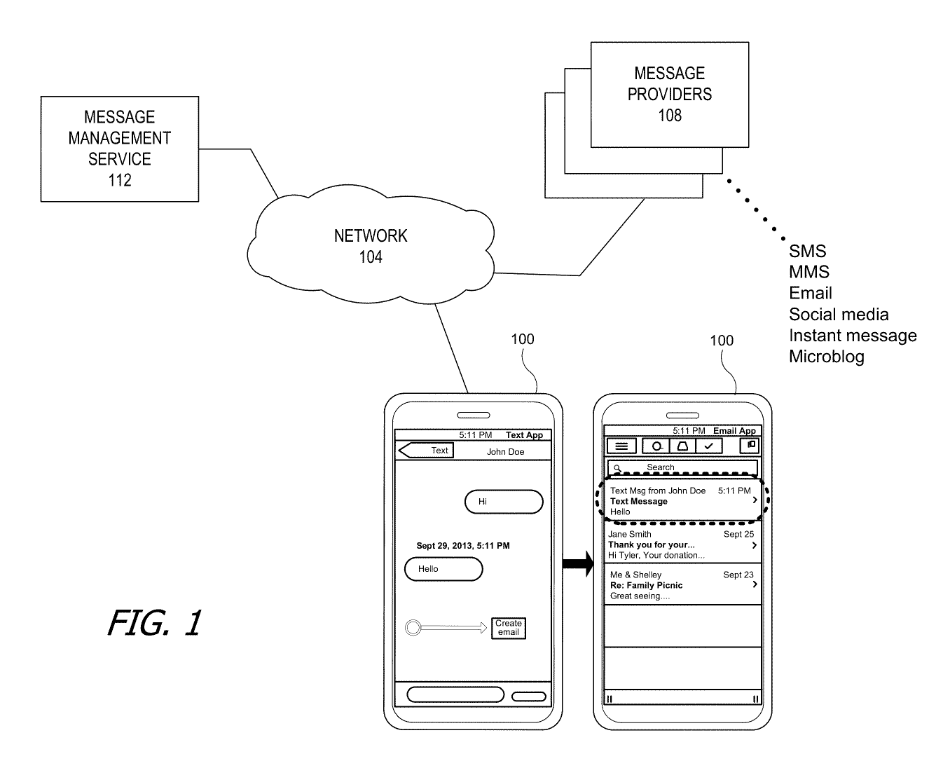

FIG. 1 shows client 100 in communication, via network 104, with message providers 108 and message management service 112, according to an embodiment of the present invention. Network 104 can be, for example, the Internet, a mobile network, a wireless network, a cellular network, or a combination thereof. As used herein, a “client” refers generally to a combination of computer hardware and/or software that enables a user to receive text messages from message providers 108 and to interact with message management service 112. For example, client 112 can be a mobile computing device executing a text app (e.g., iMessage) for receiving text messages from message providers 108 and an email app (e.g., Mailbox app) for receiving emails from message provider 108 as well as for communicating with message management service 112 to apply management services to received text messages and/or emails. As used herein “message providers” refers generally to entities that send out text messages. Example message providers include SMSCs (Short Message Service Centers), MMSCs (Multimedia Message Service Centers), instant message services, social network services, and microblogging services. Message management service 112 can include, for example, an email service that allows a user to send, receive, store, organize, and search emails, and so on. Message management service 112 can be hosted on servers maintained by a service provider and accessed via network 104.

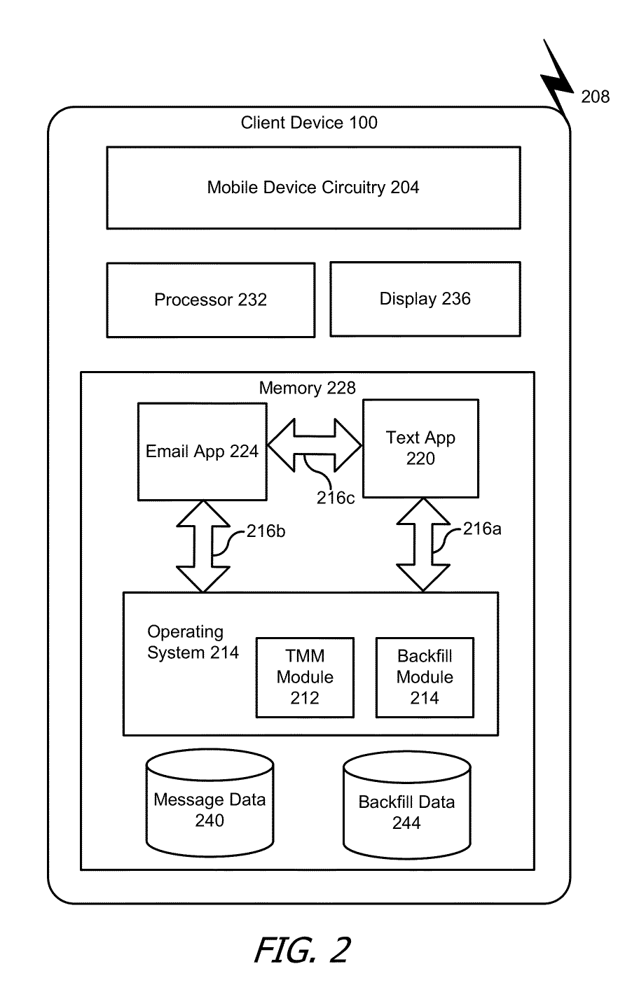

FIG. 2 shows a functional block diagram of the primary components of client device 100 of FIG. 1, according to an embodiment of the present invention. In the illustrated embodiment, client device 100 is a wireless mobile telephone, although as noted, implementation of embodiments of the present invention is not limited to this illustrated embodiment, and client device 100 can take any suitable form. In some embodiments, client device 100 can be referred to as a computer system. For example, client device 100 can be a PDA, tablet computer, laptop computer, desktop computer, a wearable computer, a pager, etc. Illustrated client device 100 includes mobile device (cell phone) circuitry 204 that enables certain telephony functions. For example, network 102 of FIG. 1 can be a mobile or cellular network, and mobile device circuitry 204 can enable client device 100 to access the mobile or cellular network via wireless communications capabilities 208. Also, for example, network 102 can be the Internet and mobile device circuitry 204 and can enable client device 100 to access the Internet via wireless communications capabilities 208. For example, wireless communications capabilities 208 can be a WiFi network that connects client device 100 to the Internet.

Client device 100 can include TMM (Text Message Management) module 212 and backfill module 214 located in an operating system 214, text-message app 220 (referred to herein as “text” app 220), and email app 224. Interfaces 216a-b communicatively couple the operating system to text app 220 and email app 224, respectively. Interface 216c communicatively couples text app 220 and email app 224. In some embodiments, interfaces 216a-c are APIs (Application Programming Interfaces) exposed by operating system 214, text app 220, and/or email app 224. Although FIG. 2 illustrates one TMM module 212, one backfill module 214, one text app 220, and one email app 224, it should be appreciated that any number of these components can be provided. Furthermore, although TMM module 212 and backfill module 214 are shown as part of operating system 214, it should be appreciated that TMM module 212 and/or backfill module 214 can be part of email app 224, text app 220, or any suitable app. In some embodiments, some functional aspects of TMM module 212 and/or backfill module 214 can be provided as part of email app 224, while other function aspects can be provided as part of text message app 220. Although text app 220 and email app 224 are shown as separate apps, it should be appreciated that these apps can be combined into a single app, or separated into more than two apps. Further, it should be appreciated that a single app having the functionality of both text app 220 and email app 224, can also include the functionality of TMM module 212 and backfill module 214. TMM module 212, backfill module 214, operating system 214, interfaces 216a-c, text app 220, and email app 224 can be implemented in the form of one or more of software, firmware, or hardware.

Client device 100 can include message data 240 and backfill data 244. In some embodiments, message data 240 can be email messages that a user has saved in his local inbox and/or other local email folders. For example, a user's local inbox and/or other local email folder can be ‘replicated’ in message data 316 of message management service. In this case, the user can access his inbox and other email folders across devices. In some embodiments, message data can be text messages received at client device. In some embodiments,

As shown in FIG. 2, in addition to exchanging data with each other via interfaces 216a-c, TMM module 212, backfill module 214, text app 220, and email app 224 can exchange data with mobile device circuitry 204. In one example, text app 220 can send text message data to email app 224, which sends a corresponding email to mobile device circuitry 204 for transmission to message management service 112. In some embodiments, operating system 214, TMM module 212, backfill module 214, interfaces 216, text app 220, and email app 224 are stored as executable instructions in memory 228 (e.g., computer readable storage medium). In these embodiments, processor 232 can access memory 228 to load and unload the executable instructions and data as needed to execute the instructions to perform the functions of the apps.

TMM module 212, backfill module 214, text app 220, and/or email app 224 can provide user interfaces and interaction capabilities via display 236. In some embodiments, TMM module 212, backfill module 214, text app 220, and/or email app 224 provide gesture-based user interfaces. However, it should be appreciated that any suitable interface can be used. In some embodiments, TMM module 212, backfill module 214, text app 220, and/or email app 224 seamlessly synchronize messages between client device 100 and message management service 112.

TMM module 212 can to provide text management services in accordance with embodiments of the present invention. In some embodiments, TMM module 212 communicates with text app 220 and email app 224 as well as with message providers 108 and message management service 112 to facilitate any or all of: converting, copying, or modifying text messages so as to create corresponding emails; adding subject lines to corresponding emails; linking corresponding emails to their respective original text message; text-message replies to corresponding emails; email-address-lookup services for email replies to text messages; and so on. Additionally TMM module 212 can be capable of detecting input gestures and translating the detected input gestures into corresponding responses for other apps on client device 100, message providers 108, and message management service 112.

Backfill module 214 can function to provide backfilling services in accordance with embodiments of the present invention. In some embodiments, backfill module 214 communicates with text app 220 and email app 224 as well as with message providers 108 and message management service 112 to facilitate any or all of: obtaining criteria for text messages and emails that are to be backfilled, identifying text messages and emails that meet said criteria, and causing said text messages and emails to be backfilled from message management service 112 and/or message provider 108 to backfill data 244 of client device 100. Additionally, some embodiments of backfill module 214 can provide a user interface into which a user can input backfilling criteria. For example, a user can designate backfilling criteria, such as messages from certain senders; messages within certain date ranges; messages having certain content; and so on.

Text app 220 can send and receive text messages. Text app 220 can be capable of communicating directly with message providers 108 and message management service 112, which, in some embodiments, can function as a proxy for message providers 108 that provide text message services. In some embodiments, text messages sent and received by text app 220 can include SMS and MMS messages. It should also be appreciated that text messages sent and received by text app 220 can include instant messages (e.g., iMessages), social network messages (e.g., Facebook messages), information streams (e.g., Tweets), or any suitable source of messages. Additionally, in some embodiments, text app 220 can be capable of detecting input gestures and translating the detected input gestures into corresponding responses for itself, other apps on client device 100, message providers 108, and message management service 112.

Email app 224 can manage the sending, receiving, and manipulation of email messages. Email app 224 can capable of communicating directly with message providers 108 and message management service 112, which, in some embodiments, is a proxy for message providers 108 that provide email services. Additionally, in some embodiments, email app 224 can detect input gestures and translate the detected input gestures into corresponding responses for itself, other apps on client device 100, message providers 108, and message management service 112.

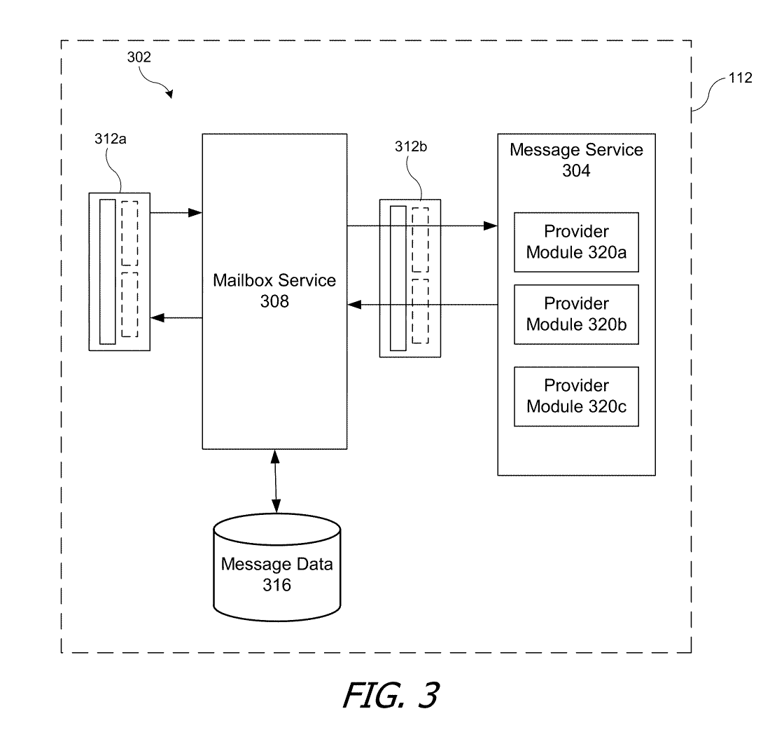

FIG. 3 shows a functional block diagram of the primary components of message management service 112 of FIG. 1, according to an embodiment of the present invention. Message management service 112, in some embodiments, can act as an intermediary between service providers 108 and client device 100. The illustrated embodiment of message management service 112 includes backend server infrastructure 302 having message service layer 304, mailbox service layer 308, transfer layers 312a-b, and data store 316. Mailbox service layer 308 can be communicatively coupled to email app 224 and possibly other apps of client device 100 via transfer layer 312a, and mailbox service layer 308 can be communicatively coupled to message providers 108 via transfer layer 312b and message service layer 304. In some embodiments, mailbox service layer 308 can enable some functionality of email app 224 and other apps of client device 100. Example benefits of mailbox service layer 308 can include supporting more responsive email app 224 functions, archiving and backfilling corresponding emails (i.e., emails corresponding to text messages), grouping and threading corresponding emails, enabling a user to search corresponding emails, and so on.

Backend server infrastructure 302 can be implemented on a managed distributed computing infrastructure, a multitenant computing infrastructure, a computing cluster, or on any suitable infrastructure. The components can include various resources that act as or provide server, load balancing, queuing, caching, database, storage, or other suitable components. Backend server infrastructure 302 can be implemented to support a client app. For example, backend server infrastructure 302 can include various design features that enable advanced features on text app 220 and email app 224 that are not natively provided by message providers 108. Backend infrastructure 302 can serve as an intermediary layer between client apps and service providers that coordinates advanced features of the client apps.

Embodiments of message service layer 304 can function to interface with message providers 108. For example, message service layer 304 can be a server in a distributed computing infrastructure that manages message communication to and from message provider 108. In some embodiments, message service layer 304 can be a collection of servers and services that collectively operate to fulfill tasks that enable interfacing and coordinating with message service providers 108. As each message service provider 108 can have a custom implementation, message service layer 304 can include provider modules or components 320a-c, each specifically configured to interface with individual message service providers 108. For example, one of provider modules 320a-c can be configured specifically for an intended message service provider 108 and can include rules and processing instructions to account for message format issues, for interpretation of message updates, specialized features or capabilities, and/or any suitable processing that can be specific to the intended message service provider 108.

In some embodiments, message management service 112 can function as a proxy for client device 100. In these embodiments, message management service 112 can receive incoming emails or text messages from message providers 108, and routes such incoming emails or text messages to client device 100. Similarly, message management service 112 receives outgoing emails or text messages from client device 100, and routes such outgoing emails or text messages to message providers 108.

In some embodiments, to facilitate receiving text messages, such as SMS and MMS messages, from message providers 108, message service layer 304 can connect to a message center, a message gateway, or other message entity. Example message centers, message gateways, and other message entities include an SMSC (Short Message Service Center), an SMS Gateway, a MMSC (Multimedia Message Service Center), a MMS Gateway, an ESME (External Short Message Entity), and an RE (Routing Entity). In some embodiments, message service layer 304 uses an IP (internet protocol) SMS connection to the message centers, message gateways, and/or other message entities. Example IP SMS connections include SMPP (Short Message Peer-to-Peer Protocol), UCP (Universal Computer Protocol), EMI (External Machine Interface), and CIMD (Computer Interface to Message Distribution) connections.

In other embodiments, to facilitate receiving text messages, such as SMS and MMS messages, from message providers 108, message service layer 304 connects directly to a wireless service provider, such as AT&T®, Verizon®, T-Mobile®, rather than connecting via a message center, gateway, or other entity. Such direct connections to a wireless service provider can be established using IP SMS connections, such as SMPP, UCP, EMI, and CIMD. It should be appreciated that, when such direct connections are established, message management service 112 can function as a message center, gateway or other entity, such as an SMSC or an SMS gateway.

In some embodiments, to facilitate receiving emails from message providers 108, embodiments of message service layer 304 can use an IMAP (Internet Message Access Protocol) connection. Such IMAP connections can made per account. A benefit of message service layer 304 establishing an IMAP connection is that any number of client apps can interact with messages. For example, a user can have multiple instances of a client app open, and each instance can share a signal IMAP connection, rather than each maintaining a separate IMAP connection.

In some embodiments, to facilitate sending text messages, such SMS and MMS messages, message service layer 304 can use typical connections, such as SMPP, UCP, EMI, and CIMD connections. As mentioned above, message service layer 304 can connect directly to a wireless service provider or indirectly via an intermediary, such as a message center, a message gateway, or any suitable message entity. In some embodiments, to facilitate sending emails, message service layer 304 can use connections, such as an SMTP (Simple Mail Transfer Protocol) connection or any suitable outbound message protocol connection. Message service layer 304 can additionally or alternatively use connections such as POP MAPI/Exchange, Service APIs and/or any suitable connection.

As another example, in some embodiments, message management service 112 can send outgoing messages to message service providers 108 using any connection made available by message service layer 304, even when replying to a message received through a particular connection. For example, client device 100 can cause message management service 112 to send out an email in reply to a received text message.

Embodiments of message service layer 304 can include logic to translate account or message updates, delivered from client device 100 and/or mailbox service 308, into appropriate actions to execute on message service providers 108. Account or message updates can include, for example, adding new folders, sorting messages into folders, starting a message, flagging a folder, marking a message as read/unread, and/or any suitable update between client device 100 and message service providers 108. Message service layer 304 can additionally include logic to translate message updates from client device 100 into instructions compatible with message service providers 108. Actions such as “archive all”, “empty trash”, “mark as unread”, and/or any suitable message update action can include logic that guides the processing and communication of message updates directed at message service providers 108.

Such translation logic for executing actions on message service providers 108 can be suitable for some message service providers 108, such as web-based email providers, that offer a variety of actions to be performed in connection with messages that are persisted to a database. However, it may not be suitable for message service providers that provide non-persistent messages, such as SMSCs that provide SMS messages, which are deleted after sending. To enable client device 100 to perform such actions in connection with non-persistent message services, embodiments of message service provider 112 can include logic to archive and backfill messages received from non-persistent services, such as SMS services. For example, mailbox service layer 308, either automatically or at the request of client device 100, can save in data store 316 corresponding emails, which are emails that correspond to text messages (e.g., text messages that do not persist at message provider 108).

Client device 100 and/or mailbox service layer 308 can cause some or all of the above-mentioned example actions to be performed on messages (e.g., corresponding emails) saved in data store 316. For example, mailbox service layer 308 can include logic to execute account or message updates, delivered from client device 100, on the saved messages. As mentioned above, account or message updates can include, for example, adding new folders, sorting messages into folders, deleted messages, staring messages, flagging a folder, marking a message as read/unread, and/or any suitable update from client device 100.

Message service layer 304, in some embodiments, can convert messages received from message service providers 108 for use within the system. It should be appreciated that email app 224 and other apps on client device 100 can convert received messages. Messages from various message providers 108 can include different formats or metadata. When converting to a mailbox native format, the message format can be normalized to a consistent and uniform message format that can be used within message management service 112 and client device 100. Normalizing the message format to a native message format can simplify design of other components in message management service 112 and client device 100 and can enable integration of a range of message providers 108. Herein, native message format describes a standardized data modeling approach to embody content and parameters of the message. It should be appreciated that email app 224 and other apps of client device 100 can convert received messages to a native message format.

In some embodiments, mailbox service layer 308 coordinates with email app 224 and other apps on client device 100 to manage messages for a user. Mailbox service layer 308 can provide any number of services. An example service is message windowing. Message windowing, in embodiments, describes the transfer of only immediately relevant messages to a client app. For example, in some embodiments, mailbox service layer 308 only transfers information for the 100 most recent messages when a user accesses his inbox even if there are 500 unread messages the user has not seen. Another example service is converting or incorporating individual messages into a message thread or conversation. A thread or conversation can be any set related messages such as: messages replying to another message; messages forwarding another message; messages with shared subjects, bodies, senders, recipients, dates, and/or times; messages quoting a portion of another message; and/or any other grouping of messages. In some embodiments, mailbox service layer 308 can use a provider-assigned thread ID or alternatively an inbox scanning process to add messages to a thread or conversation.

Mailbox service layer 308 or alternatively message service layer 304 can manage state and windowing of multiple message streams. Message streams, in some embodiments, describe different collections of messages. Email app 224 of client device 100 can be designed to provide frequent access to certain message streams. An email inbox folder, for example, can be one message stream, where other message streams can include archives, backfilled messages, message folders, labels, special folders (e.g., starred messages or deferred messages), and/or any suitable collection of messages. Maintaining the message streams in the backend infrastructure can avoid delays caused by on-demand access of an outside service provider when switching between message streams.

Stream or message records can be created and/or modified to appropriately direct message sorting and organization. For example, mailbox service layer 308 can additionally organize a message according to sorting history. In this way, moving a message to another stream places that message at the top of the stream when presented to a user of email app 224 of client device 100. This sorting organization can be an overriding sorting parameter on top of chronological organization. When receiving updates from email app 224, mailbox service layer 308 can additionally translate the update into a message provider update. For example, if an email is moved to the top of the inbox on email app 224, mailbox service 308 can create a “tell message provider to move conversation to top of inbox” instruction to deliver to the appropriate message provider 108.

Mailbox service layer 308, in some embodiments, can additionally enable messages to be conditionally acted upon when a condition is satisfied. In a first variation, a user can place messages in a deferred message list with an assigned reminder condition. The reminder condition can be a time condition (e.g., “remind me in 24 hours”, “remind me on June 22”, etc.), or a condition based on geo-location of the user, geo-location of other users, geo-location of users relative to the device user, response by another recipient of the message, response to another message, device access (e.g., next time on desktop computer), a combination of Boolean logic for multiple conditions, programmatic logic (e.g., accessed through an API), and/or any suitable conditions. Once a condition or conditions are satisfied, mailbox service layer can 308 take the appropriate action. The action or response, in some embodiments, can include moving the message or message thread or conversation into the inbox. This can involve sending data to email app 224 of client device 100. The action can alternatively include any suitable action such as moving to another folder, sending a pre-composed response, archiving a message, deleting a message, sharing a message on a social network, sending an alert, or any suitable action.

As noted above, once a text message is read, it can be automatically marked read and the user cannot mark it unread. If the user is unable to respond immediately, other text messages received later in the day can bury it. This can result in the user forgetting to respond. In some embodiments of the present invention, a text message can be converted, copied, or modified so as to create a corresponding email, which can be added to an inbox, where it can be read and later marked unread to remind a user to respond, for example.

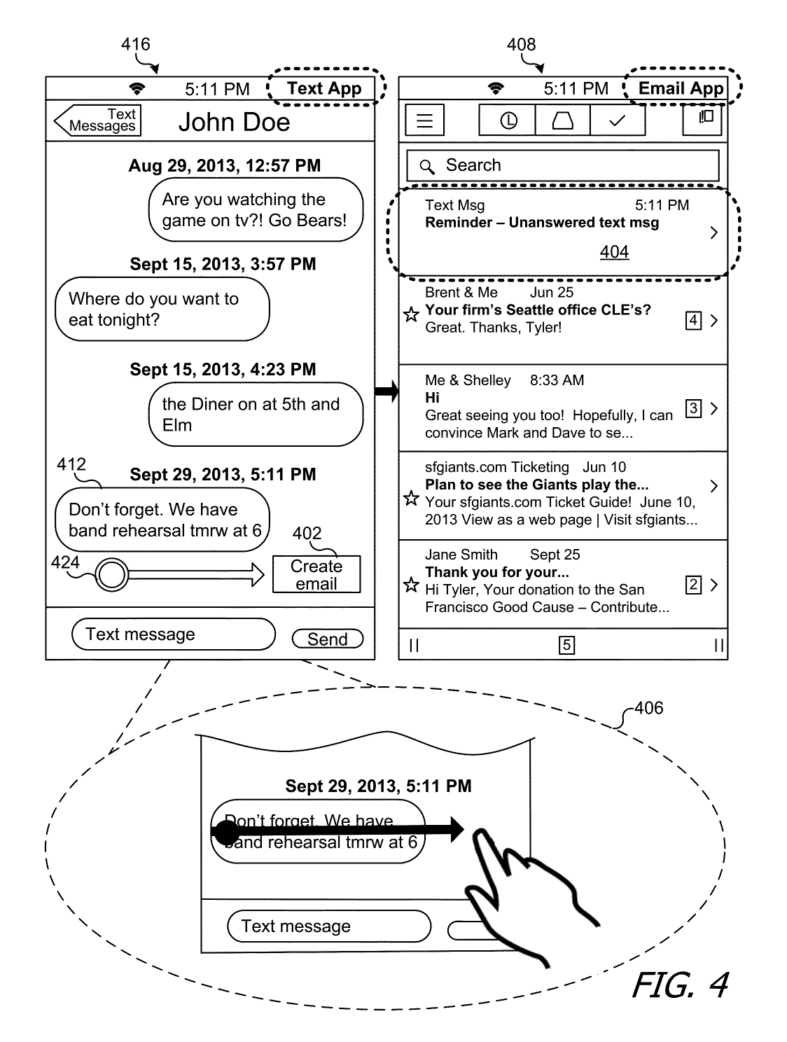

Examples of such corresponding emails are described herein with reference to FIGS. 4-6, which show example interfaces of text app 220 and email app 224, according to embodiments of the present invention.

Referring first to FIG. 4, interface 416, which is for text app 220, shows a conversation as a sequence of text messages between a user of client 100 and another user, John Doe. In some embodiments, a user can provide an input into interface 416 that causes a corresponding email to be created for one or more of the text messages (referred to herein as a “create-email input”). In some embodiments, a user can provide a create-email input by pressing or otherwise interacting with an icon, button, graphic, or any suitable element of interface 416. For example, a user can provide a create-email input by pressing “Create email” element 402, pressing or swiping “swipe arrow” element 424, and/or swiping “swipe arrow” element 424 to cause “Create email” element to appear 402 and then pressing “Create email” element once it appears. In some embodiments, a create-email input can be gesture based. For example, as illustrated in partial view 406 of interface 416, a user can provide a create-email input by swiping across a text message for which he wants to create a corresponding email (referred to herein as a “create-email gesture”). In some embodiments, a create-email gesture can be swiping just above or below a text message. In some embodiments, a create-email gesture can cause one or both of “swipe arrow” element 424 and “Create email” element 402 to appear, and the user can then provide a create-email input by pressing or swiping “swipe arrow” element 424 and/or “Create email”.

Interface 408, which is for email app 224, shows an email inbox that lists emails between a user of client 100 and other users. Corresponding email 404 corresponds to text message 412, which is shown in interface 416 of text app 220. As noted above, in some embodiments, to create corresponding email 404, a user, when viewing interface 416 of text app 220, can provide a create-email input for text message 412. Do so, for example, the user can swipe his finger across text message 412, swipe just above or below text message 412, press “Create email” element 402, press or swipe “arrow” 424, or any combination thereof.

Corresponding email 404 can remind a user of an unanswered text message, without providing details. Its subject field displays, “Reminder—Unanswered Text”. However, its body is blank, and its sender field displays, “Text Msg”, rather than actual sender information. Displaying “Text Msg”, rather than sender information, reminds a user that the emails is a converted, copied, or modified text message, which can prevent confusion regarding its origin. In some embodiments, the timestamp indicates the receipt time of corresponding email 404. In other embodiments, the timestamp indicates the receipt time of the original text message 412. Because corresponding email 404 is an email, a user can review it and later mark it as ‘unread’ to remind the user to reply to the original text message, complete a relevant task, quickly reference the message, and so on.

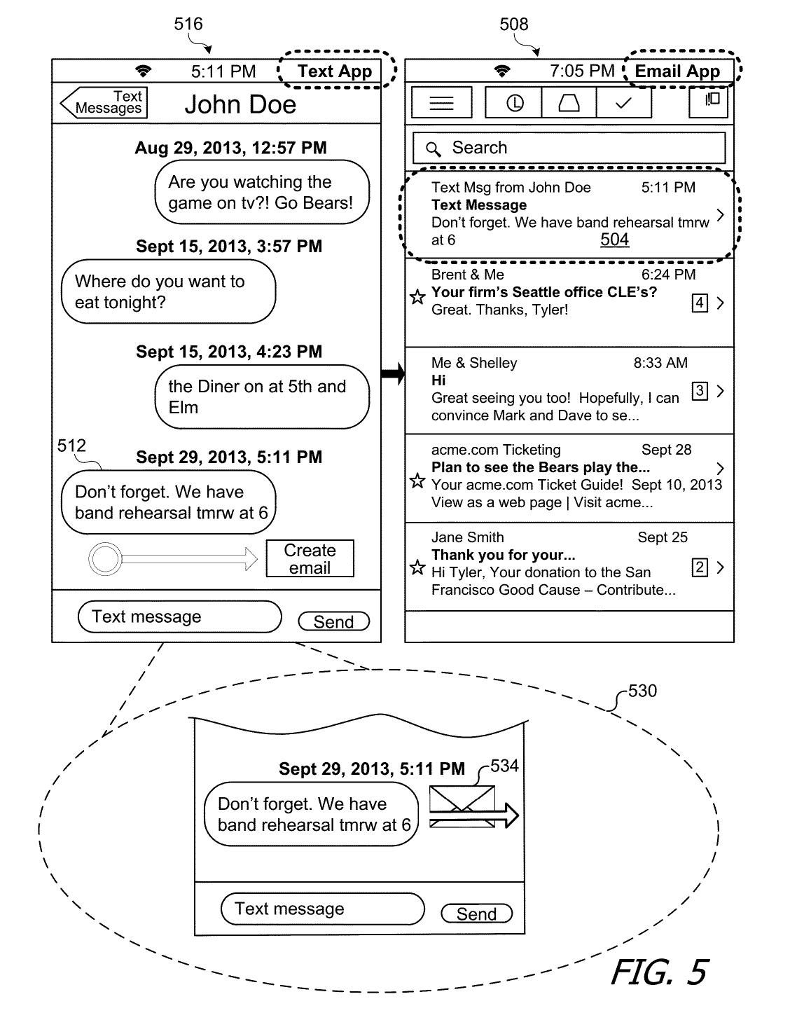

Referring to FIG. 5, another variation of a corresponding email is shown. Corresponding email 504 of email app interface 508 corresponds to text message 512 of text app interface 516. Unlike corresponding email 404, corresponding email 504 includes in its body the actual text of the original text message 512, and therefore reminds a user of the message content, in addition to reminding the user to reply, complete a relevant task, quickly access information, etc. Its subject field displays “Text Message”, and its sender field displays “Text Msg from John Doe”. Accordingly, the subject and sender fields combine to remind a user of an unanswered text message from a particular sender, and the body field reminds the user of the message content.

In some embodiments, once a text message has been converted, modified, or copied so as to create a corresponding email, indicator can be associated with the text message (referred to herein as “email-created indicator”). For example, as illustrated in partial view 530 of interface 516, email-created indicator 534 can be an icon, button, graphic, or any suitable element displayed in association with the text message. In some embodiments, text app 220, email app 224, and/or TMM module 212 cause email-created indicator 534 to be displayed, once a corresponding email has been requested and/or created.

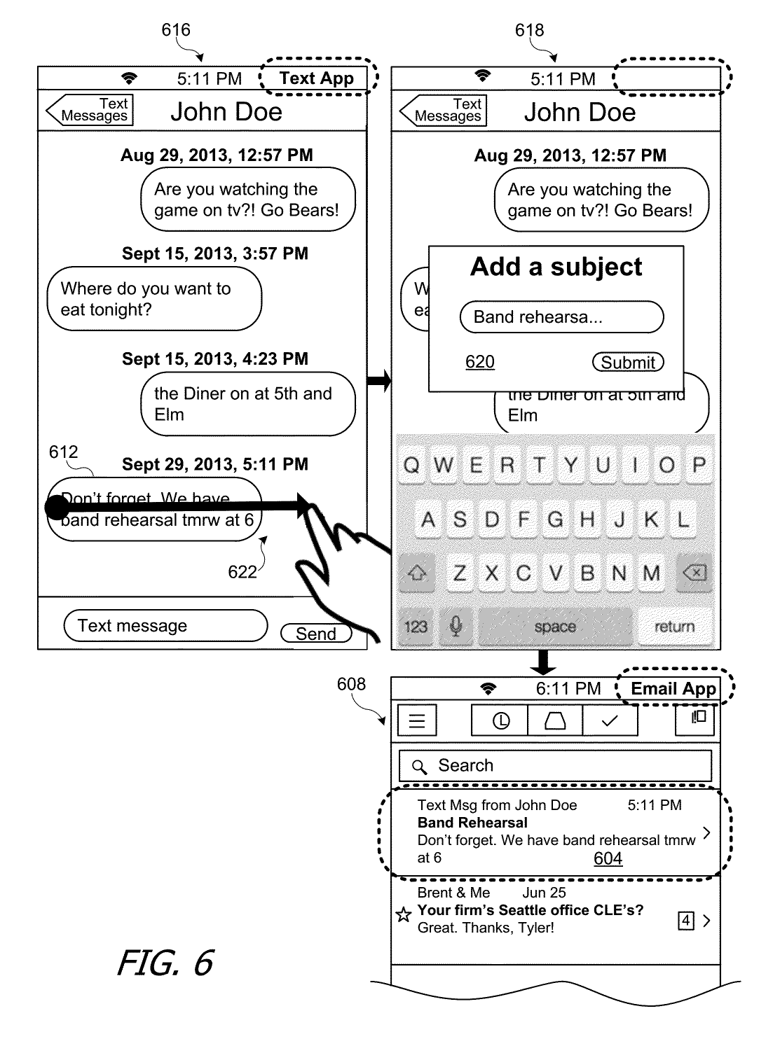

Referring to FIG. 6, another example of creating a corresponding email from a text message is shown. Corresponding email 604 of email app interface 608 corresponds to text message 612 of text app interface 616. Corresponding email 604 is the same as corresponding email 504, expect it includes a user-specified subject. In some embodiments, a user can be prompted to input a subject when corresponding email 604 is created, as shown on interface 618. In this example, create-email gesture 622 of swiping across text message 612 can cause subject-text box 620 to pop up and prompt a user to input a subject. Thus, when later reviewing corresponding email 604, the user can quickly recall the nature of the message and any actions the user needs to take.

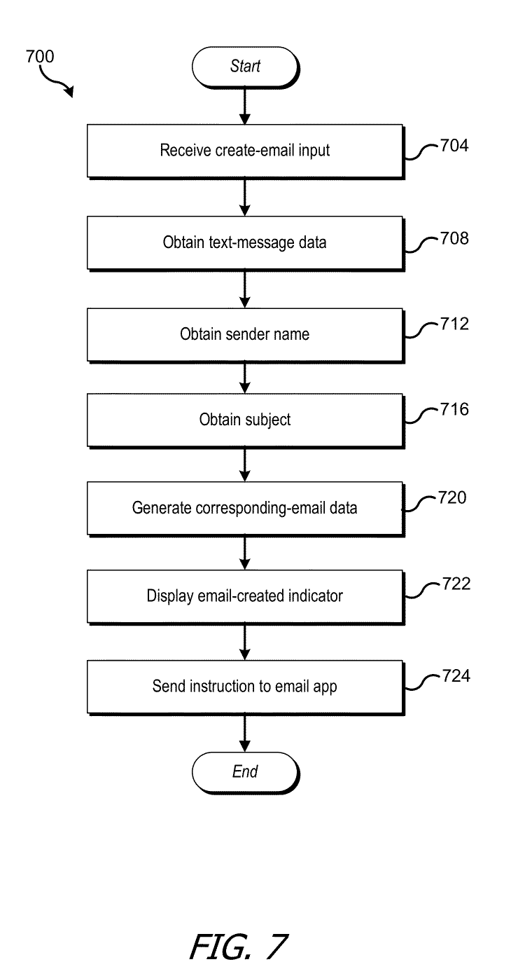

Turning now to FIG. 7, process 700 is shown for creating corresponding emails, according to embodiments of the present invention. For example, process 700 can be applied to convert, copy, or modify one of text messages 412, 512, or 612 so as to create its respective corresponding email 404, 504, or 604. Process 700 is described herein as being implemented on a client device (e.g., client device 100). However, it should be appreciated that process 700 can be implemented on a server (e.g., message management service 112). It should be also appreciated that process 700 can be collaboratively implemented by a client device(s) and a server(s).

For example, a user can invoke process 700 upon reviewing a text message that the user would like to convert, copy, or modify so as to create a corresponding email so that the user can mark the message as unread, reply by email, add the message to a digital calendar, archive the message, group the message with other, similar messages, and so on. In some embodiments, to invoke process 700, the user provides a create-email input, such as by inputting to client device 100 a create-email gesture. At block 704, in some embodiments, the create-email input can be received. For example, a create-email input can be received when a gesture-detection routine of TMM module 212 or some other routine of TMM module 212 or another app detects a create-email gesture, such as a user sliding his finger horizontally across or near the text message to be converted, copied, or modified, as illustrated at 622 of FIG. 6. In some embodiments, create-email input can be a voice command from a user.

At block 708, in some embodiments, data related to the text message can be obtained (referred to herein as “text-message data”). For example, TMM module 212 can obtain text-message data, also referred to herein as message data, from text app 220. In some embodiments, the text-message data can be the text-message file (e.g., SMS file) of the text message. In other embodiments, the text-message data can be a portion of the data of the text-message file. For example, the text-message data can include the header (referred to here as “text-message header”) and the body (referred to here as “text-message body”) of the text-message file. The text-message header can include a sender identifier (Sender ID), such as the telephone number of the device from which the text message was sent. The sender identifier can also include the name of the sender, or any information that uniquely identifies the sender. The header can also include formatting information. Additionally, the text-message header can include a timestamp that indicates the time of receipt and/or the time at which the text message was sent. The text-message body can include the text that is the actual content of the text message. In some embodiments, the text-message data can include a message identifier. For example, text app 220 can assign a unique message ID to the original text message upon receipt.

At block 712, in some embodiments, the name of the sender of the text message can be obtained, if available. For example, TMM module 212 can query contact data stored on mobile device 100 for a name associated with the Sender ID that was included in the text-message data obtained at block 708. At block 716, in some embodiments, a subject for the corresponding email can be obtained. For example, as shown in FIG. 6, TMM module 212 can display a subject-text box 620 that prompts a user to input a subject. The user can type a subject into subject-text box 620 and press submit. In some embodiments, TMM module 212 auto-generates a subject. For example, the subject can be auto-generated based on the message content, the sender information, the time stamp, or a combination thereof.

At block 720, in some embodiments, data can be generated for the corresponding email (referred to herein as “corresponding-email data”). For example, the corresponding-email data can include a header (referred to herein as “corresponding-email header”) and a body (referred to herein as “corresponding-email body”) for the corresponding email.

The corresponding-email header can include an indication that the corresponding email is a converted, copied, or modified text message. Such an indication can be provided, e.g., by including in the header words such as “Text Message”, “Text Msg”, “Txt Msg”. FIG. 4 illustrates that such an indication can be included in the Sender (From) field, FIG. 5. illustrates that such an indication can be included in both the Sender (From) and Subject fields, and FIG. 6 illustrates that such an indication can be included in the Sender (From) field. The corresponding-email header can also include an indication of the sender. For example, the telephone number of the device used to send the original text message or, as illustrated in FIGS. 5 and 6, the name of the sender can be included in the Sender (From) field. As shown in FIG. 4, sender information need not be included in the corresponding-email header. In such embodiments, the Sender (From) field can simply include an indication that the corresponding email is a converted, copied, or modified text message. This can, for example, prevent a user from mistakenly thinking that he received an email from the sender. The generated corresponding-email header can also include the subject obtained at block 716.

The corresponding-email body can include text that is the actual content of the text message. For example, the corresponding-email body can include all or some of the text-message body of the text message. Corresponding emails 504 and 604 of FIGS. 5 and 6, respectively, illustrate embodiments where the entire text-message body is included in the corresponding-email body. It should be appreciated the corresponding-email body can include any of the information included in the corresponding-email header.

In some embodiments, at block 722 an email-created indicator can be displayed in association with the original text message. For example, as illustrated in FIG. 5, email-created element 534 can be displayed in association with the original text message. At block 724, in some embodiments, instructions to create a corresponding email can be sent. For example, TMM module 212 can send such instructions to email app 224. In other embodiments, other email clients can be used to create the email.

In some embodiments, TMM module 212 can send to email app 224 some or all of the corresponding-message data, either formatted or unformatted, along with an instruction that causes email app 224 to display in its inbox a new email that includes some or all of the corresponding-message data. To do so, for example, email app 224 can use the corresponding-message data to compose and send the corresponding email to an email address associated with the inbox of the user who created the corresponding email. Thus, email app 224 can send the corresponding email to an address located at message provider 108 and/or message management service 112, which can add the corresponding email to the inbox of the email account. Upon synching with message provider 108 and/or message management service 112, email app 224 will display the corresponding email in the inbox on client device 100.

In other embodiments, email app 224 can use the corresponding-message data to create the corresponding email as a new message in the local inbox on client device 100. When email app 224 synchronizes with message provider 108 and/or message management service 112, the corresponding email is added to the corresponding email account stored at message provider 108 and/or message management service 112.

As described above, the Sender (From) field of the corresponding email can include the sender's name, phone number, and/or an indication that the corresponding email is a copied, modified, or converted text message. Accordingly, as illustrated by corresponding emails 404, 504, and 604 of FIGS. 4-6, the corresponding email can appear in the inbox as a new email and it will indicate in the Sender (From) field the sender's name, phone number, and/or that it is a converted, modified, or copied text message.

In some embodiments, an email address of the sender of the text message can be located. This can be accomplished in a a manner similar to obtaining the sender's name, as described above with reference to block 712. For example, TMM 212 can identify an email address associated with the Sender ID (e.g., phone number) included in the text-message header, e.g., by processing the user's stored contact information. Further, according to these embodiments, the email address of the sender can be included in the Sender (From) field of the corresponding email. Accordingly, the corresponding email can appear to have been sent as an email from the sender of text message.

Once the text message has been converted, modified, or copied so as to create a corresponding email, the user can manage the corresponding email like any other email. For example user can review the message and later mark it unread. In addition, unlike text messages, the corresponding email message can persist at message provider 108 and/or message management service 112. Accordingly, if the user loses his client device 100, the user can recover the message from message provider 108 and/or message management service 112. In some embodiments, message management service 112 can apply services to the corresponding email, such as organizing the corresponding email in a folder; archiving the corresponding email; adding the corresponding email to a thread; grouping the corresponding email with other emails having similar content, subject, and/or date; grouping it with emails involving the same sender(s)/recipient(s); adding the corresponding message to a list (e.g. to-do); deferring presentation of the corresponding email in the inbox until a condition is satisfied (e.g., user can set a 24-hour reminder, etc.); indexing the corresponding email so the user can later search for and retrieve it; adding the corresponding email to a calendar, and so on.

Certain embodiments of the present invention enable a user to reply to a corresponding email. For example, a user who uses email app 224 to review a corresponding email can desire to reply to the original text message from email app 224, rather than having to switch to text app 220 and then search for the original message or its. Further, for example, such a user may desire to use email app 224 to reply by text or email.

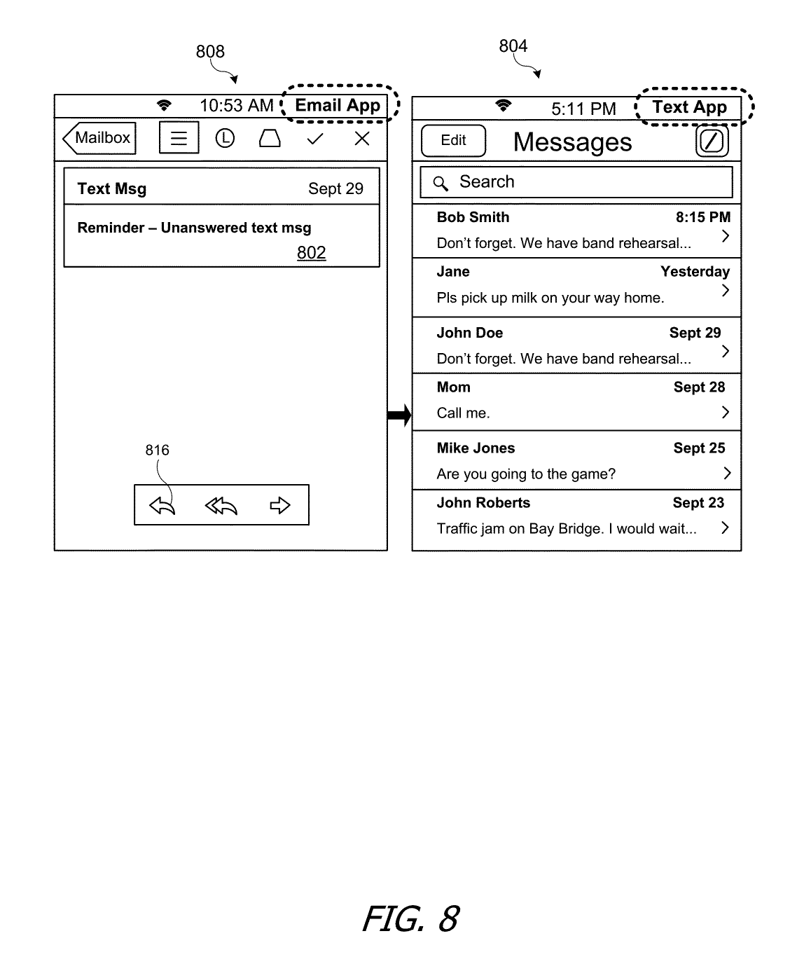

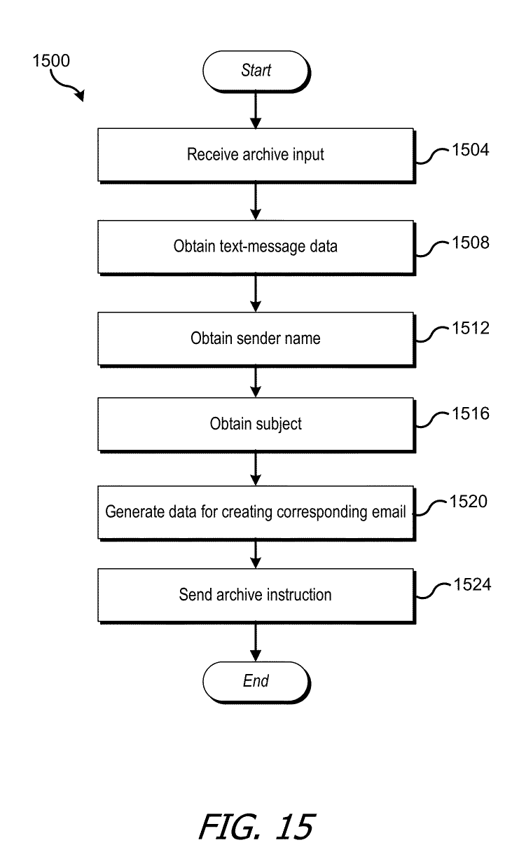

Examples of using email app 224 to reply to corresponding messages are described herein with reference to FIGS. 8-15. FIGS. 8-14 show example reply-related interfaces of email app 224 and text app 220 in accordance with an embodiment of the present invention. FIG. 15 shows a process for using email app 224 to reply to a corresponding email in accordance with an embodiment of the present invention.

More specifically, the example reply-related interfaces of FIGS. 8-10 illustrate ‘text-message replies’ to corresponding emails in accordance with an embodiment of the present invention. For example, as described above, embodiments of the present invention convert, modify, or copy a message that was originally a text message so as to create an email that corresponds to the original text message. FIGS. 8-10 illustrate embodiments of the present invention that enable a user who is using email app 224 to view the corresponding email to also use email app 224 to reply “in kind” to the original text message. For example, when viewing the corresponding email using email app 224, a user can select a reply icon, button, or any suitable element presented by email app 224 to send a text-message reply to the original text message.

With reference to FIG. 8, in some embodiments, in the event email app 224 receives instruction to reply to corresponding email 802, TMM module 212 can cause text app 220 to launch and display text-message home screen 804. A user can then scroll through text messages listed on home screen 804 to locate the original text message or its sender, and reply by text using text app 220.

According to an operational example with reference to FIG. 8, message window 808 of email app 224 can display corresponding email 802, which does not include any text-message data of the original text message. Instead, it simply provides a generic reminder of an unanswered text message and a timestamp indicating time-of-receipt of corresponding email 802. To reply using email app 224, a user can select reply element 816. Responsive to this selection, email app 224 can process corresponding-email header information, and, based thereon, can recognize that corresponding email 802 is a converted, copied, or modified text message. For example, email app 224 can recognize in the corresponding-email header key terms, such as “Text Msg”, “Text Message”, or it can recognize in the corresponding-email header text-message specific data, such as a Message ID or Sender ID that is indicative of text messages. Upon recognizing that the corresponding email is a converted, copied, or modified text message, email app 224 can send to TMM module 212 relevant data, such as the corresponding email header and body. TMM module 212 can use the relevant data to attempt to locate the original text message. For example, TMM module 212 can use the Message ID, Sender ID, timestamp, and/or message body to locate the original text message. However, in this example, corresponding email 802, and any data obtained therefrom, does not include any information about the original text message, and therefore TMM module 212 cannot locate the original text message. Accordingly, TMM module can launch home screen 804 of text app 220, so that a user can manually scroll through listed text messages to locate the original text message or its sender.

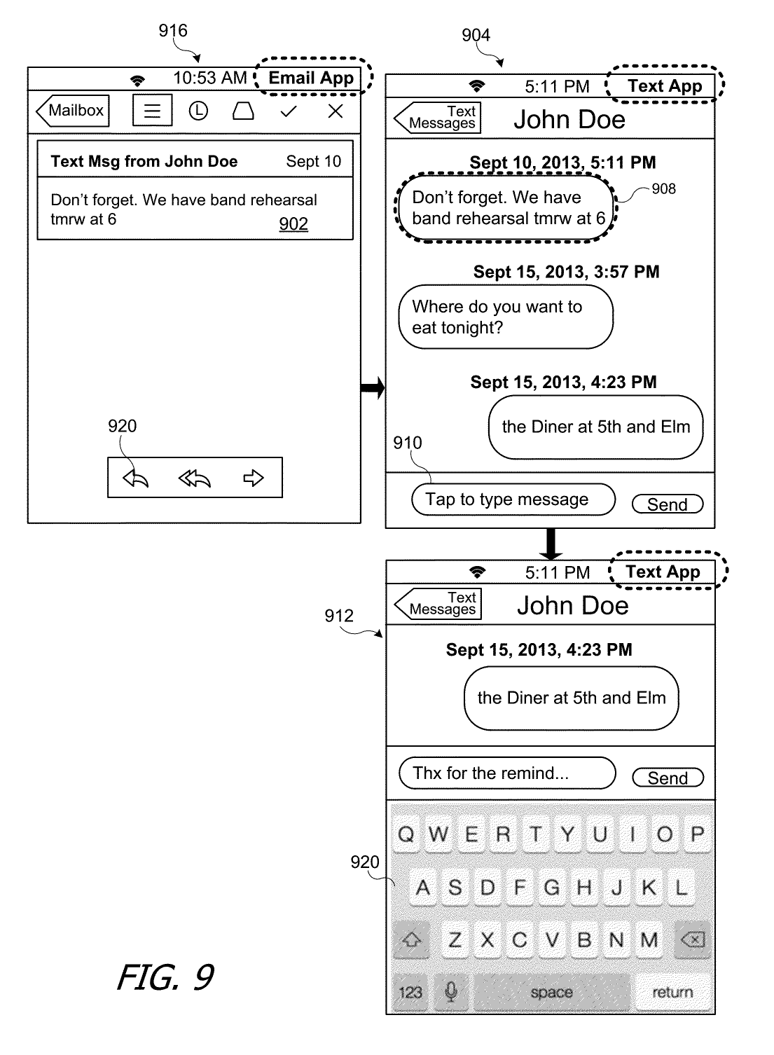

Referring now to FIG. 9, in some embodiments, in the event email app 224 receives instruction to reply to corresponding email 902, TMM module 212 can cause text app 220 to launch and display a conversation on interface 904 that includes original text message 908. As illustrated, TMM module 212 can cause original text message 908 to be highlighted. A user can opt to reply at the end of conversation 904, e.g., by tapping reply-text box 910, which can cause text app 220 to open reply window 912 and present keyboard 920 for typing in the reply message.

In an operational example with reference to FIG. 9, message window 916 of email app 224 can display corresponding email 902, which includes the name of the sender and text-message body (e.g., the text of the actual message content), among other data. Responsive to a user selection of reply element 920, email app 224 can process corresponding-email header information to recognize that corresponding email 902 is a converted, copied, or modified text message, and can send to TMM module 212 the name of the sender and the text-message body, which TMM module 212 can use to locate original text message 908. TMM module 212 launches a display of conversation 904 and highlights original text message 908.

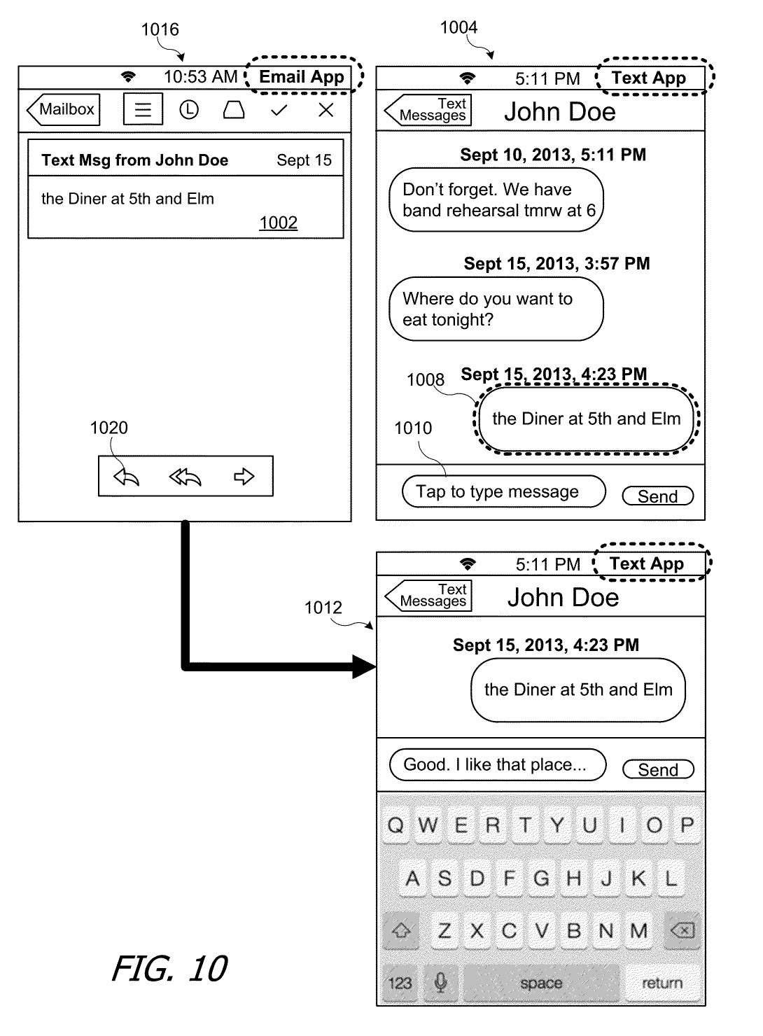

In instances where a user seeks to reply to an original text message that is not the most recent message in a conversation, such as original text message 908 described above, TMM module 212 can be configured, by default, to cause text app 220 to open conversation 904 to provide context and to notify a user that he is not replying to the last message in conversation 904, rather than to cause text app 220 to directly proceed to opening reply window 912. On the other hand, as illustrated in FIG. 10, responsive to a user selecting reply element 1020 in instances where an original text message is the most recent message in a conversation, such as original text message 1008, TMM module 212 can be configured to enable a single-action reply by causing text app 220 to directly proceed to opening reply window 1012. In this example, conversation 1004 is not displayed to a user. In some embodiments, TMM module 212 can be configured to enable a single-action reply, even if the original text message is not the most recent message in a conversation.

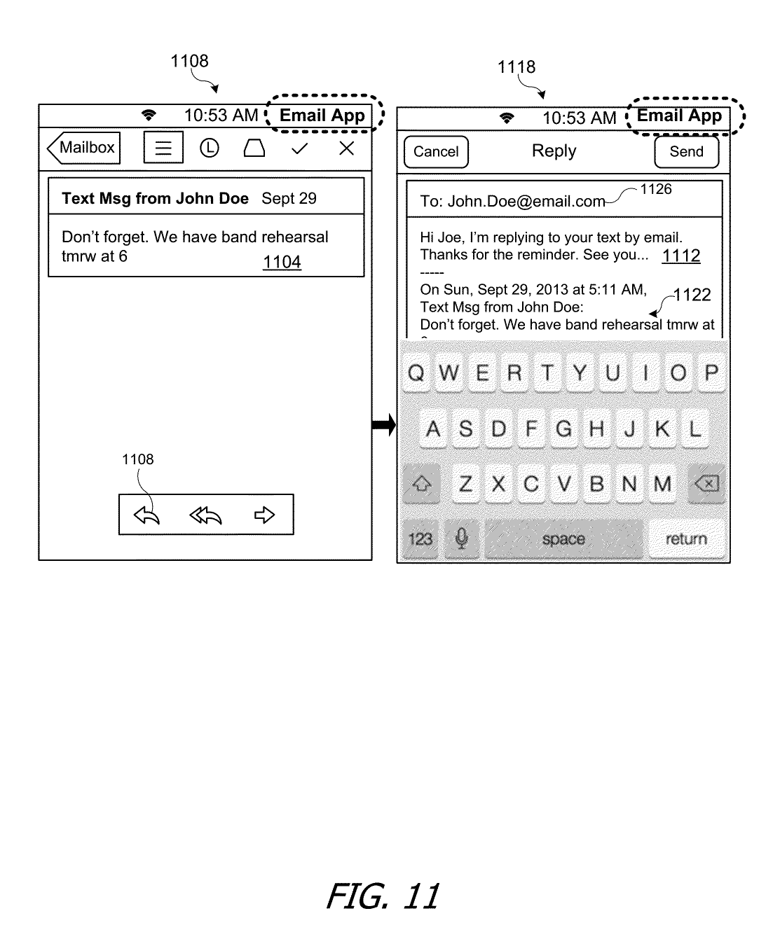

FIGS. 11-14 show example interfaces related to ‘email replies’ to corresponding emails in accordance with an embodiment of the present invention. For example, these figures illustrate embodiments of the present invention that enable a user who is using email app 224 to view a corresponding email to also use email app 224 to reply “by email” to the original text message.

With reference to FIG. 11, to send a reply email to a corresponding email 1104, a user can select a reply element 1108, thereby causing email app 224 to display a draft reply email 1112 in a compose-email window 1118. In some embodiments, email app 224 can pre-populate a reply-text portion 1122 of draft reply email 1112 with some or all of the corresponding email 1104. In the illustrated example, the reply-text portion 1122 indicates “Text Msg from John Doe.” Thus, when John Doe—the sender of the original text message—receives the reply email, the reply-text portion 1122 can inform him that the reply email is an email reply to his original text message. The reply-text portion 1122 can include additional information about the original text message, such as the text-message body, which can be reviewed to provide context for the reply email.

In some embodiments, an email address 1126 of the sender of the original text message can be auto-populated in the Recipient (To) Field of the draft reply email 1112. For example, to obtain the email address 1126, email app 224 can send to TMM module 212 relevant data, such as the corresponding-email header, which can include the name, telephone number, or some other identifying information of the sender of the original text message. TMM module 212 can access contact information stored on client device 120 to locate an email address that corresponds with the relevant identifying data (e.g., name or phone number of sender of original text message). If successful, TMM module 212 can send the email address to email app 224. In some embodiments, if an email address is not located, TMM module 212 can use the relevant data to obtain a telephone number of the sender of the original text message. Such telephone number can be obtained from contact data stored on client device 100 or from the original text message. TMM module 212 can send the telephone number to email app 224, which can include the telephone number in the Recipient (To) Field of the draft reply email 1112. In this case, for example, the reply email can be sent as a server-to-phone SMS text message. In other embodiments, if an email address is not located, TMM module 212 can invoke text app 220 to reply instead by text, e.g., as illustrated in FIGS. 8-10.

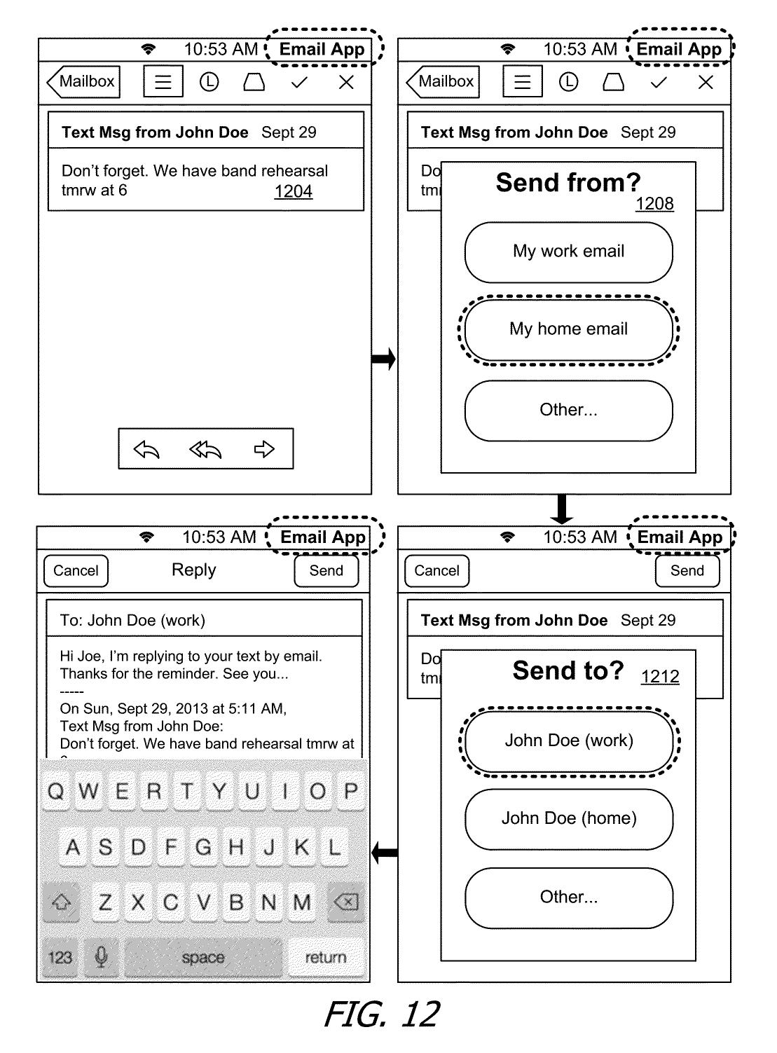

In some embodiments, a user is able to associate one or more email accounts with email app 224. For example, the user can use email app 224 to manage a first email account having a first email address (e.g., work email) and a second email account have a second email address (e.g., home email). As illustrated in FIG. 12, when composing a reply to to a corresponding email 1204, email app 224 can display an address-selection box 1208, which presents a user-selectable element for each of the email accounts. The illustrated address-selection box 1208 presents a user-selectable element labeled “My work email” and another labeled “My home email”. The word “my” can be included to remind a user that he is selecting which of his own email account to send from, not an email account to send to. Similarly, if more than one email address is located for the recipient (i.e., the sender of the original text message), email app 224 can display an address-selection box 1212, which presents user-selectable elements for each of the recipient's email addresses.

As previously described, FIGS. 8-10 illustrate ‘text replies’ to corresponding emails, whereas FIGS. 11-12 illustrate ‘email replies’. It should be appreciated that a user can desire an option of selecting whether to reply by text or email. For example, a user can prefer to send text replies to some people, and email replies to others. Also, for example, the user can prefer text replies for some subject matter, and email replies for other subject matter.

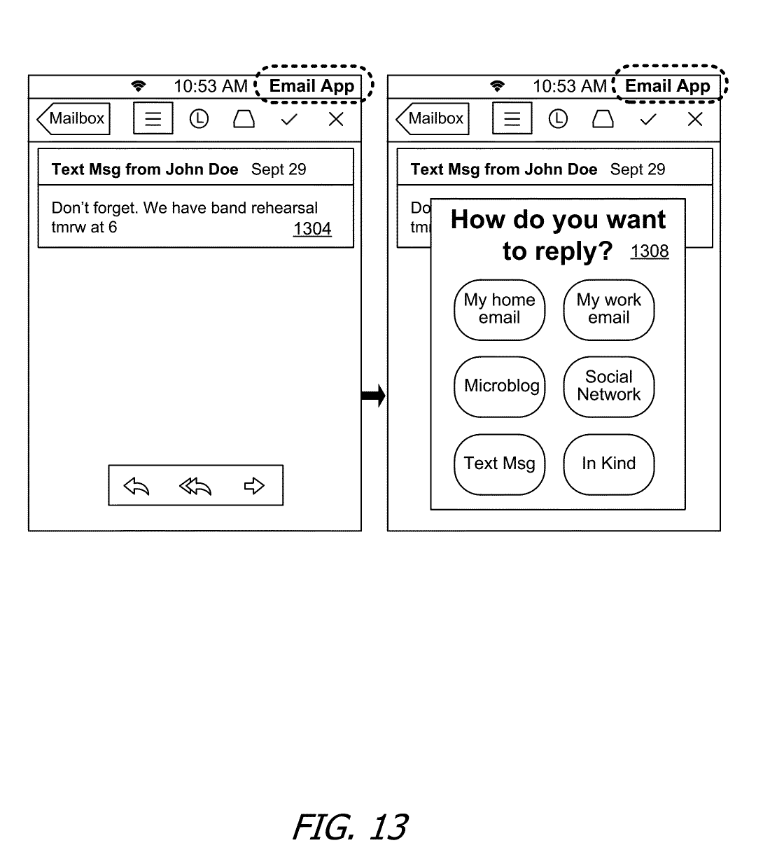

FIG. 13 illustrates an embodiment of the present invention that enables a user to select a channel for replying to a corresponding email. For example, a user can select to reply “by text” or “by email”, or by some other channel, such as a social network service, a microblogging service, etc. In operation, upon receiving an instruction to reply to a corresponding email 1304, email app 224 can display a channel-selection box 1308, which presents a user-selectable element for each of the channels available for replying. In some embodiments, the user can choose from among multiple accounts in the same channel. For example, channel-selection box 1308 provides a user an option of selecting one of two email accounts: “My home email” and “My work email”. For example, if a user selects “Text Msg”, the reply can be sent according to the examples provided with reference to FIGS. 8-10. Also for example, if a user selects “My home email” or “My work email”, the reply can be sent according to the examples provided with reference to FIGS. 11-12.

In some embodiments, rather than providing an option to select a reply channel (e.g., text or email), a particular reply channel is auto-selected. Such auto-selection can be based at least in part on historical correspondence between the parties. For example, if a user historically “text replies” to corresponding emails that correspond to text messages from a particular text-message sender, TMM 212, upon receiving an instruction to reply, can automatically display to the user a text-message reply window (e.g., window 1012 of FIG. 10) or the relevant text-message conversation (conversation 904 of FIG. 9), rather than presenting channel-selection box 1308. Similarly, for example, if a user historically “email replies”, TMM 212 can automatically display to the user a draft reply email (e.g., email 1112 of FIG. 11) or email-account-selection box 1208, rather than presenting channel-selection box 1308.

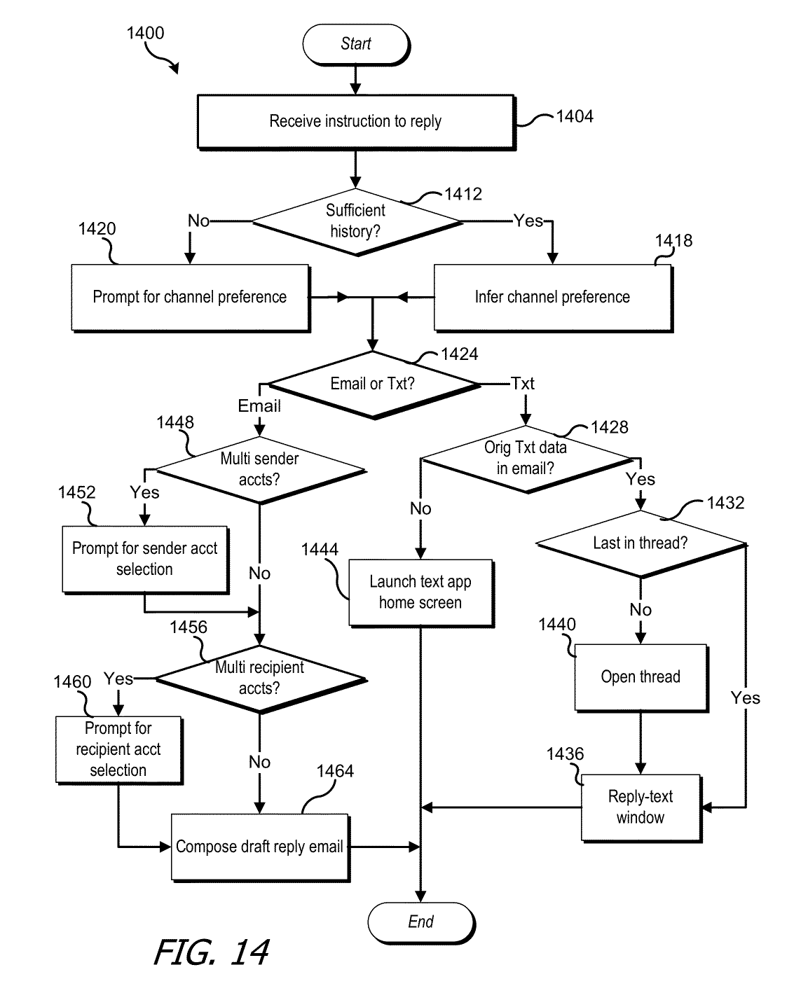

Turning now to FIG. 14, process 1400 can be provided for replying to a corresponding email in accordance with an embodiment of the present invention. For example, process 1400 can be applied to compose and send an email or text-message reply to the sender of the original text message that corresponds to the corresponding email. Process 1400 is described herein as being implemented on a client device (e.g., client device 100). However, it should be appreciated that process 1400 can be implemented on a server (e.g., message management service 112). It should be also appreciated that process 1400 can be collaboratively implemented by a client device(s) and a server(s).

For example, a user can invoke process 1400 upon reviewing a corresponding email to which he would like to send a reply email or text. In some embodiments, to invoke process 1400, a user inputs to client device 100 a reply instruction. For example, a user can select a reply icon, button, graphic or any suitable element, such as reply element 920 of FIG. 9, associated with a corresponding message to which the user wants to send a reply email or text. At block 1404, in some embodiments, the reply instruction can be received. For example, email app 224, while displaying to a user a corresponding email, can receive a reply instruction upon the user selecting a reply icon, button, graphic, or any suitable element associate with the corresponding message.

At block 1412, in some embodiments, it can be determined whether there is sufficient correspondence history for the relevant sender to infer a preferred message channel for the reply. The determination at block 1412 can be based on volume and/or frequency of historical messages. For example, process 1400 can determine whether historical messages sent from the relevant sender to the relevant recipient satisfy a threshold number for a period, such as one hundred messages exchanged in the last month. Also, for example, process 1400 can determine whether historical messages sent from the relevant sender to any recipient satisfy a threshold number for a period.

If sufficient correspondence history exists, then process 1400 can proceed to block 1418, where, in some embodiments, it can infer (a.k.a., auto-select) a channel (e.g., text or email) for the reply. For example, if a user historically “text replies” to corresponding emails that correspond to text messages from particular text-message sender, process 1400 can infer that a “text” is the preferred channel for the reply. Also for example, if the sender always replies by email, regardless of the recipient, the process 1400 can infer that “email” is the preferred channel for the reply. Referring again to block 1412, if sufficient correspondence history does not exist, then process 1400 can proceed to block 1420, where, in some embodiments, it can prompt a user to input a channel preference. Process 1400 can display a prompt to the sender, asking the sender to designate or select a channel for the reply. For example, as illustrated in FIG. 13, email app 224 can display a channel-selection box 1308, which presents a user-selectable element for each of the available channels, such as text and email.

At block 1424, if text is selected as the channel to be used to send the reply, then process 1400 can proceed to block 1428, where, in some embodiments, it can determine whether the corresponding email in question includes any text-message data from the original text message. As described above, the corresponding email can include all or part of the text-message header and/or the text-message body. The text-message header can include a Sender ID, such as the name of the sender or the telephone number of the device from which the text message was sent, and a Message ID, such as a unique identifier assigned by the mobile phone to the text message. The text-message body can include the text that is the actual content of the text message. At block 1428, if the corresponding email includes text-message data, then at block 1432, process 1400, in some embodiments, can determine whether the original text message of the corresponding email is the last message in its conversation. Here, the process 1400 can locate the original text message on client device 100 and determines if the original text message is last in its conversation, like original text message 1008 of FIG. 10.

If the original text message is last in its conversation, process 1400 can proceed to block 1436. Here, in some embodiments, process 1400 can display a reply-text window. For example, as illustrated in FIG. 10, where the original text message is the most recent message in a conversation, like original text message 1008, process 1400 can displays a reply-text window, similar to reply window 1012, into which the sender can type the reply message. Referring again to block 1432, if the original text message is not the most recent message in its conversation, then process 1400 can, in some embodiments, proceed to block 1440, where it can display the conversation. For example, as illustrated in FIG. 9, TMM module 212 can cause text app 220 to launch and display the conversation, such as conversation 904, that includes the original text message, such as text message 908, which is not the most recent message in the conversation.

Once the conversation is displayed to a user, process 1400 can proceed to block 1436, where, in some embodiments, the reply-text window can be displayed so that the user can type in the reply message. In some embodiments, process 1400 can proceed from block 1440 to block 1436, when a user opts to reply at the end of the conversation by tapping a reply-text box, such as box 910, which can cause text app 220 to open a reply window, such as reply window 912, and present a keyboard so the user can type in the reply message.

Referring again to block 1428, if the text-message data of the original text message is not included in the corresponding email, process 1400 can proceed to block 1444, where, in some embodiments, it can launch the home screen of the text message application. Here, the corresponding email to which the user is replying may not include any text-message data of the original text message. Instead, for example, it can simply provide a generic reminder of an unanswered text message and a timestamp indicating time-of-receipt of its corresponding email, as shown in FIG. 4. Accordingly, because there is no data available that can be used to locate and reply to the original text message or its sender, process 1400 can launch the text app home screen so the user can manually search for the original text message or its sender. For example, as illustrated in FIG. 8, TMM module 212 can cause text app 220 to launch and display a text-message home screen 804, and a user can then scroll through text messages listed on the home screen 804 to locate the original text message, and reply by text using text app 220.

Referring again to block 1424, if email is selected as the channel to be used to send the reply, then process 1400 can proceed to block 1448, where, in some embodiments, it can determine if the sender of the reply message has multiple email accounts. For example, process 1400 can determine if the sender has more than one email account linked to email app 224 and able to be used to send the reply. If it is determined that the sender has more than one email account, process 1400 can proceed to block 1452, where it can prompt for a sender to indicate which of the multiple email accounts to use for sending the reply. An example of block 1452 is provided in FIG. 12, where account-selection window 1208 prompts the sender to select an email account to use for the reply.

Once an email account of the user is selected, process 1400 can proceed to block 1456, where, in some embodiments, it can determine if the recipient of the reply (i.e., the sender of the original text message) has multiple email accounts. Here, for example, process 1400 can determine whether the contact data stored on client device 100 has multiple email addresses for the recipient. If multiple recipient addresses exist, process 1400 can proceed to block 1460, where it can prompt for selection of a recipient email address. An example of block 1460 is provided in FIG. 12, where account-selection window 1212 can prompt the sender to select an account of the recipient to send the reply to. Process 1400 can proceed to block 1464, where, in some embodiments, it can compose a draft reply email. Here, for example, email app 224 can open a reply window for composing the reply email and inputting the recipient email address in the Recipient (To) field. The reply email can be a direct reply to the corresponding email and, as illustrated by reply email 1112 of FIG. 11, can include all or some of the corresponding email in the reply text. Therefore, process 1400 can end. The user can compose and send the reply, e.g., by email app 224 or text app 220, depending on the reply channel selected.

Embodiments of the invention enable archiving text messages. For example, upon receiving a text message, a user can instruct client device 100 to create a corresponding email and archive it at message management service 112. Accordingly, the text messages can persist on the servers of message management service 112. For example, a user who loses his mobile phone can recover the archived text messages from message management service 112. It should also be appreciated that corresponding emails can be archived at message provider 108.

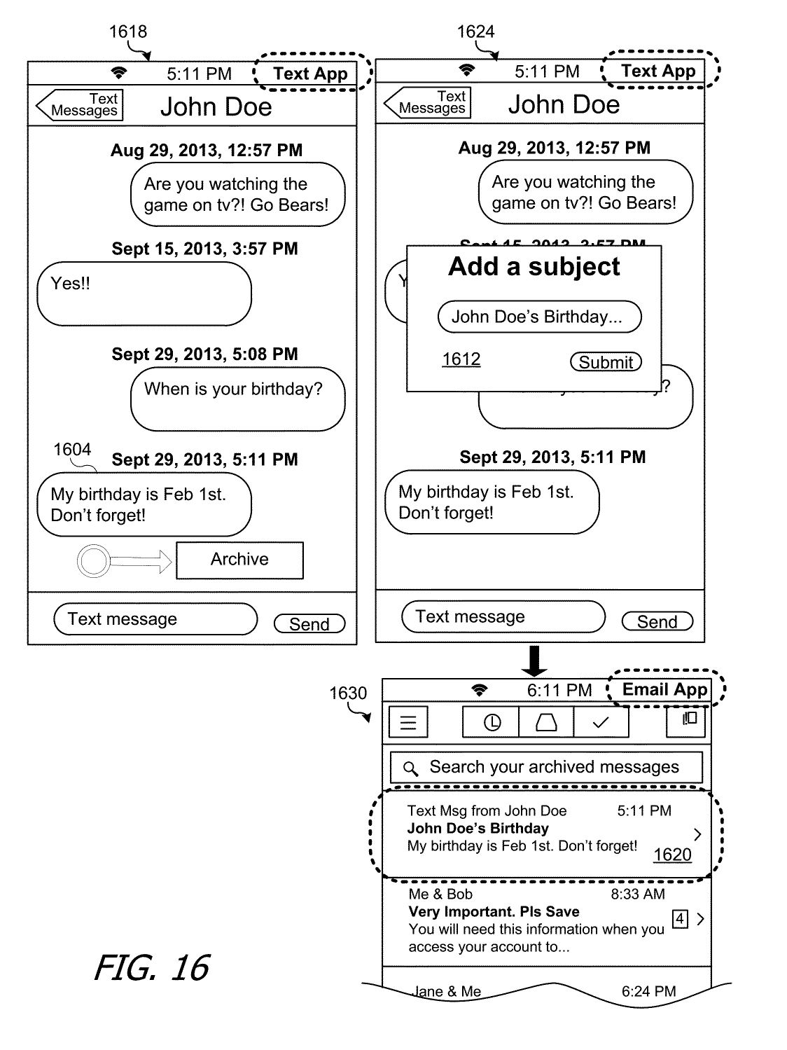

Examples of archiving text messages are described herein with reference to FIGS. 15-16. FIG. 15 is a flow diagram of process 1500 that can be used for archiving text messages in accordance with embodiments of the present invention. FIG. 16 shows interfaces related to archiving in accordance with embodiments of the present invention. For example, process 1500 can be applied to archive text message 1604 to message management service 112. For illustrative purposes, process 1500 is described herein as being collaboratively implemented by a client device (e.g., client device 100) and a server (e.g., message management service 112). However, it should be appreciated that process 1500 can be implemented by either a client device or a server.

For example, a user can invoke process 1500 upon reviewing a text message that the user would like to archive. In some embodiments, to invoke process 1500, the user can provide an archive input to client device 100. At block 1504, in some embodiments, the archive input can be received. Providing and receiving archive inputs can be similar to providing and receiving create-email input, described above with reference to FIGS. 4-7.

At block 1508, text-message data can be obtained from the text message, in some embodiments. Example text-message data and techniques for obtaining it are described above with reference to FIG. 7. At block 1512, the name of the sender of the text message can obtained, if available. For example, process 1500 can query contact data stored on mobile device 100 for a name associated with a sender identifier included in the text-message data obtained at block 1508. At block 1516, in some embodiments, a subject for the corresponding email can be obtained. For example, as illustrated in FIG. 16, process 1500 can display subject-text box 1612, which prompts a user to input a subject. The user can type a subject into subject-text box 1612 and press submit. In some embodiments, process 1500 can auto-generate a subject. For example, the subject can be auto-generated based on the message content, the sender information, the time stamp, or a combination thereof.

At block 1520, in some embodiments, data can be generated for the purpose of converting, modifying, copying the text message so as to create a corresponding email. For example, as described above, the corresponding-email data can include corresponding-email header and corresponding-email body. In some embodiments, this step can be performed by message management service 112. For example, client device 100 can send to send text-message data, sender information, and/or the subject to message management service 112. In some embodiments, email app 224 of client device can perform this step. At block 1524, in some embodiments, archive instructions can be created and sent. For example, archive instructions can be instruction to use the text-message data sent along with the archive instructions to create a corresponding email and then archive the email. For example, client device sends such instructions to message management service 112, along with data generated at block 1520. It should also be appreciated that process 1500 sends such instructions to email app 224 and/or message provider 108.

In some embodiments, process 1500 can send to message management service 112 and/or email app 224 some or all of the corresponding-message data, either formatted or unformatted, along with an instruction that causes message management service 112 and/or email app 224 to create and archive a new corresponding email that includes some or all of the corresponding-message data. To do so, for example, message management service 112 and/or email app 224 can use the corresponding-message data to compose and send the corresponding email to an address at message management service 112, where the address can be an archive folder associated with an email account of a user.

As describe above, the Sender (From) field of the corresponding email can include the sender's name, phone number, and/or an indication that it is a converted, modified, or copied text message. Accordingly, as illustrated by archived email 1620 of FIG. 16, the text message can appear as a corresponding email in the archive folder of the inbox of the user's email account and it can indicate, for example, in the Sender (From) field the sender's name, phone number, and/or that it is a converted, modified, or copied text message.

In some embodiments, client device can be capable of intelligently selecting text messages to archive, even in the absence archive input from a user. For example, the client device can automatically initiate process 1500 to archive select text messages, e.g., message from a particular sender and/or messages that include particular subject matter, as indicated by keywords and phrases. The intelligent selection can be learned over time by observing a user's archive requests. Also, the intelligent selection can be based on user preferences. In some embodiments, a text message can be converted, modified, or copied so as to create a corresponding email and archived at message management service 112 without email app 224 presenting an interface, e.g., interface 1630, to a user. For example, a user can provide an archive input to interface 1618 of text app 220, and the remaining steps can be accomplished without user input and without having to display additional interfaces to the user. In some embodiments, a user can be optionally prompted to input a subject into subject-input box 1612, but the remaining steps can be done without user input and without displaying additional interfaces to the user. For example, in some embodiments, email app 224 does not launch and display interface 1630.

Embodiments of the invention enable backfilling text messages. In some embodiments, backfilling can include downloading, from a remote data store to a local data store on a client device, messages that meet certain criteria. For example, backfill module 214 can coordinate with message management service 112 to download certain corresponding emails, e.g., emails that are less than two weeks old, from message store 316 of message management service 112 to backfill data 224 on client device 100. In some embodiments, in event email app 224 requests an email that is not in a user's local inbox and that meets backfilling criteria, email app 224 can quickly obtain the email from backfill database 244, rather than having to download the email from message management service 112. This can save time and battery power of client device 100.

For example, if a user clears a conversation from his inbox, and later converts, modifies, or copies a new text message so as to create a corresponding email in that conversation, email app 224 can retrieve the conversation from backfill data store 224, and present the corresponding email in the ‘context’ of the conversation. Also for example, if a user starts a conversation on first client device, and then switches to a second client device, backfill module 214 of the second client device can backfill the conversation to backfill data 244 of the second device. In this example, if the user receives a new text message in that conversation and converts, modifies, or copies that text message so as to create a corresponding email, email app 224 can retrieve the other emails in the conversation from backfill data store 224, and present the corresponding email along with the other emails in the conversation, even the emails that correspond to text messages received at the first device.

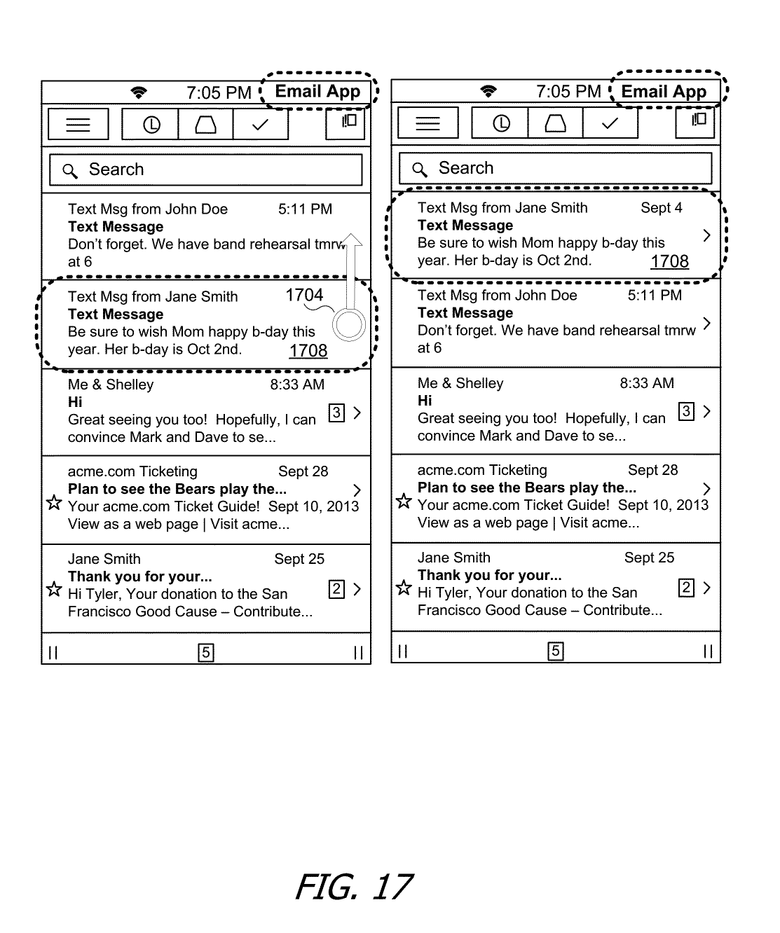

FIG. 17 shows a user interface related to prioritization of emails in accordance with an embodiment of the present invention. In some embodiments, a user can input a “move” gesture to move an email up or down in the inbox. For example, move gesture 1704 moves email 1708 to the top of the inbox. Also illustrated in FIG. 17 is that the corresponding emails can be listed at the top of the inbox, so as to emphasize them.

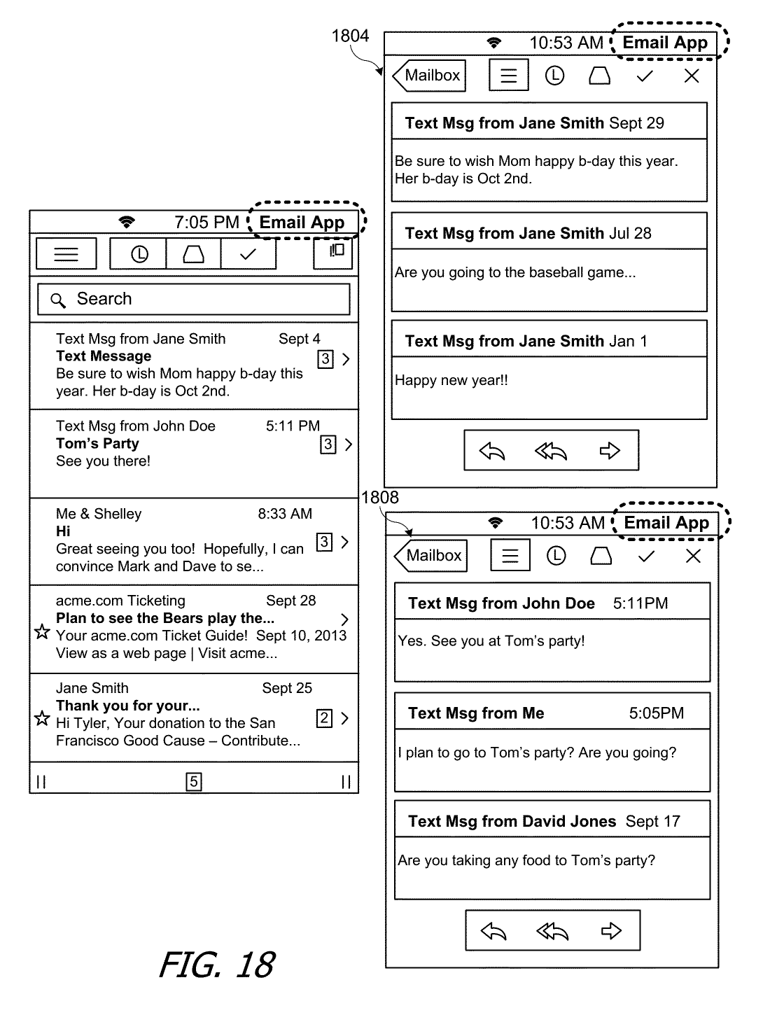

FIG. 18 shows a user interface related to grouping into conversations text messages that have been converted, modified, or copied so as to create corresponding emails in accordance with an embodiment of the present invention. Conversation 1804 is organized by sender. For example, it includes the three most recent text messages from Jane Smith, even though the messages relate to different subject matter. Conversation 1808 is organized by subject based on keywords and phrases included in the message body. For example, conversation 1808 includes messages from multiple senders that relate to the same party.

While some embodiments can include message management services that can manage text messages by converting, copying, or modifying text messages to emails, one skilled in the art will recognize that numerous modifications are possible. For example, embodiments can be capable of managing a message received in any unmanaged data format and/or from any unmanaged communication channel (referred to herein as “an unmanaged message”). An unmanaged message can be an instant message, a message associated with networking service and/or microblog, a text message, as well as any other type of message received in any unmanaged data format and/or from any unmanaged communication channel. In some embodiments, an unmanaged message can be managed by converting, copying, or modifying the unmanaged massage to any type of managed data format.

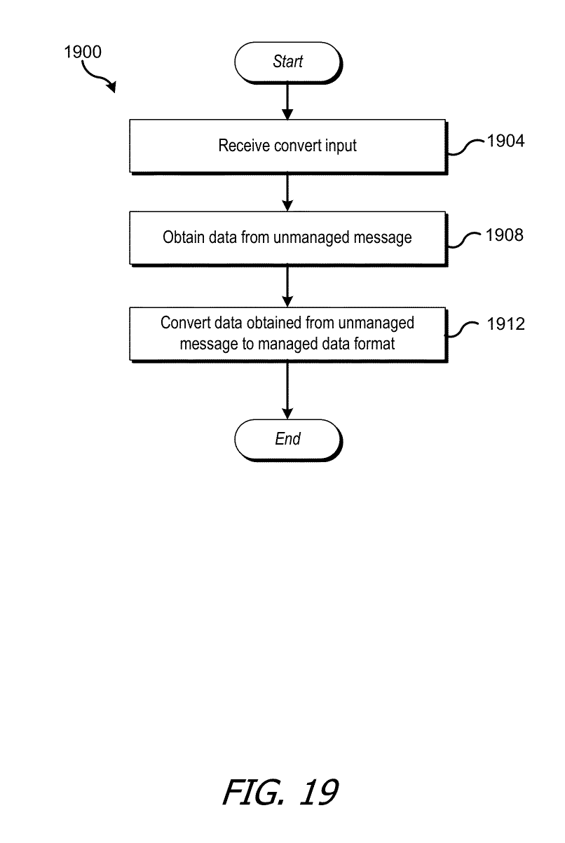

FIG. 19 shows a flow diagram of a process for converting, copying, or modifying unmanaged data into a managed data format according to embodiments of the present invention. For example, process 1900 can be applied to convert, copy, or modify an unmanaged message so as to create a corresponding message in a managed data format. Process 1900 is described herein as being implemented on a client device (e.g., client device 100). However, it should be appreciated that process 1900 can be implemented on a server (e.g., message management service 112). It should be also appreciated that process 1900 can be collaboratively implemented by a client device(s) and a server(s).

In some embodiments, a user can invoke process 1900 upon reviewing an unmanaged message that the user would like to convert, copy, or modify into a managed data format so that the user can store, organize, etc. the message. For example, upon converting an unmanaged message into a managed data format, a user can store and organize the message, such as by adding the message to a digital calendar or email inbox, archiving the message in a data store, grouping the message with other messages, and so on.

In some embodiments, to invoke process 1900, a user provides a convert input, such as by inputting to client device 100 a convert gesture, which can be similar to the above-described create-email gesture. At block 1904, in some embodiments, such convert input can be received. For example, a convert input can be received when a gesture-detection routine of TMM module 212 or some other routine of TMM module 212 or another app detects a convert gesture, such as a user sliding his finger horizontally across or near an unmanaged massage to be converted, copied, or modified to a managed data format. In some embodiments, convert input can be a voice command from a user.

At block 1908, in some embodiments, data from an unmanaged message can be obtained. TMM module 212 can obtain data from an unmanaged message from text app 220, or some other app such as a social network app, microblogging app, etc. that received the unmanaged message. In some embodiments, data from an unmanaged message can be a text-message file (e.g., SMS file) or a portion thereof. In some embodiments, data from an unmanaged message can be a portion of a data stream from an instant message or conversation hosted by a social networking service or microblog. At block 1912, in some embodiments, data obtained from an unmanaged message can be converted to a managed data format. For example, a text message can be converted to any type of managed data format, such as basic a text format, a text format with scaling and/or styling, a simple and/or an extended encoding format, an image format, HTML, or any other suitable data format.

In some embodiments, converting data obtained from an unmanaged message to managed data format can included adding data to the message. For example, metadata can be added to the message so that the message can be organized. Such added data can indicate an original source of the message, a client app or device used to create and/or send the message, a message provider, a sender of the message, contact information of a sender of the message, a time of receipt, a message identifier, a thread identifier, etc. For example, in the event an unmanaged message is a text message, data can be added that indicates the message was originally a text message, a sender of the message (name, telephone number, user name, etc.), time of receipt, device identifier, message identifier, thread identifier, etc. In another example, in the event an unmanaged message is an instant message, data can be added that indicates the message was originally an instant message (e.g., such data can indicate the message service used to send the message), sender identifier, time of receipt, etc. Once an unmanaged message has been converted, modified, or copied to a managed data format, a user can manage the message using any appropriate application or service that is compatable with the managed data format.

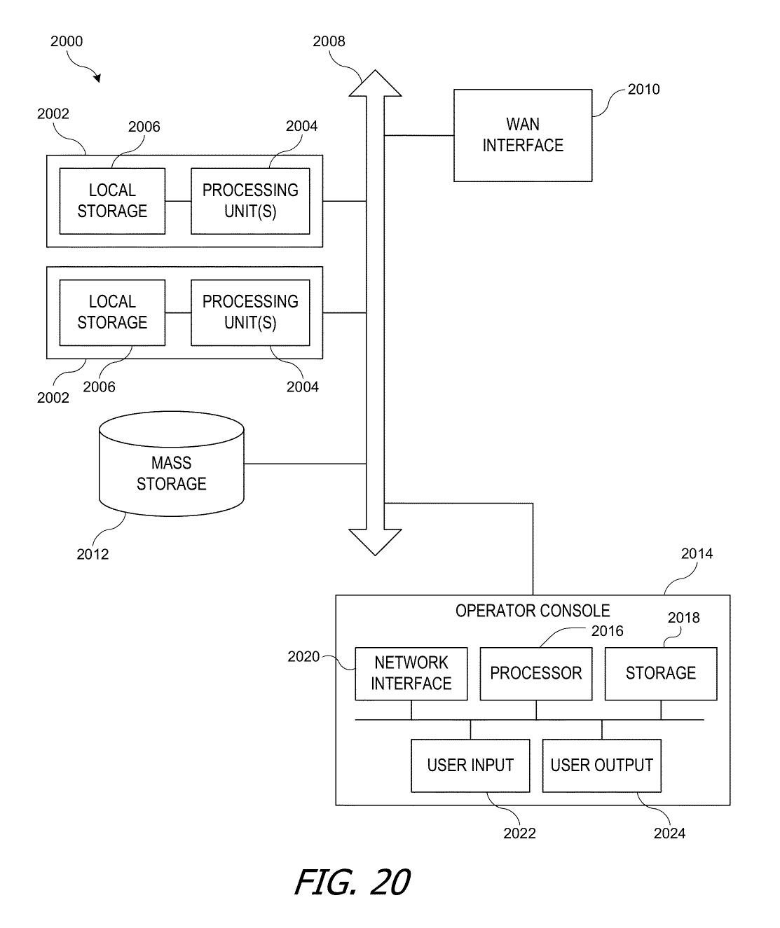

Various operations described herein can be implemented on server systems, which can be of generally conventional design. FIG. 20 is a simplified block diagram illustrating a representative server system 2000. In various embodiments, server system 2000 or similar systems can implement backend server infrastructure 302, message service 304, mailbox service 308, transfer layers 312a-b, message providers 108, message management service 112, or any other services or servers described herein or portions thereof. In various embodiments, server system 2000 or similar systems can enable execution of some or all aspects of processes 700, 1400, 1500, and 1900.

Server system 2000 can have a modular design that incorporates a number of modules 2002 (e.g., blades in a blade server implementation); while two modules 2002 are shown, any number can be provided. Each module 2002 can include processing unit(s) 2004 and local storage 2006.

Processing unit(s) 2004 can include a single processor, which can have one or more cores, or multiple processors. In some embodiments, processing unit(s) 2004 can include a general-purpose primary processor as well as one or more special-purpose co-processors such as graphics processors, digital signal processors, or the like. In some embodiments, some or all processing units 2004 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 2004 can execute instructions stored in local storage 2006. Any type of processors in any combination can be included in processing unit(s) 2004.

Local storage 2006 can include volatile storage media (e.g., conventional DRAM, SRAM, SDRAM, or the like) and/or non-volatile storage media (e.g., magnetic or optical disk, flash memory, or the like). Storage media incorporated in local storage 2006 can be fixed, removable or upgradeable as desired. Local storage 2006 can be physically or logically divided into various subunits such as a system memory, a read-only memory (ROM), and a permanent storage device. The system memory can be a read-and-write memory device or a volatile read-and-write memory, such as dynamic random access memory. The system memory can store some or all of the instructions and data that processing unit(s) 2004 need at runtime. The ROM can store static data and instructions that are needed by processing unit(s) 2006. The permanent storage device can be a read-and-write memory device. This permanent storage device can be a non-volatile memory unit that stores instructions and data even when module 2002 is powered down. The term “storage media” as used herein includes any medium in which data can be stored indefinitely (subject to overwriting, electrical disturbance, power loss, or the like) and does not include carrier waves and transitory electronic signals passing wirelessly or over wired connections.

In some embodiments, local storage 2006 can store one or more software programs to be executed by processing unit(s) 2004, such as an operating system and/or programs implementing various server functions such as functions of backend server infrastructure 302, message service 304, mailbox service 308, transfer layers 312a-b, or any other service(s) or server(s) associated with message management service 112 of FIG. 1. In some embodiments, local storage 2006 can store one or more software programs to be executed by processing unit(s) 2004, such as an operating system and/or programs implementing various server functions such as some or all aspects of processes 700, 1400, 1500, and 1900. “Software” refers generally to sequences of instructions that, when executed by processing unit(s) 2004 cause server system 2000 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 2004. Software can be implemented as a single program or a collection of separate programs or program modules that interact as desired. From local storage 2006 (or non-local storage described below), processing unit(s) 2004 can retrieve program instructions to execute and data to process in order to execute various operations described herein.

In some server systems 2000, multiple modules 2002 can be interconnected via a bus 2008, forming a local area network that supports communication between modules 2002 and other components of server system 2000. Bus 2008 can be implemented using various technologies including server racks, hubs, routers, etc.

A wide area network (WAN) interface 2010 can provide data communication capability between the local area network (bus 2008) and a larger network, such as the Internet. Conventional or other communications technologies can be used, including wired (e.g., Ethernet, IEEE 802.3 standards) and/or wireless technologies (e.g., Wi-Fi, IEEE 802.11 standards).

In some embodiments, local storage 2006 is intended to provide working memory for processing unit(s) 2004, providing fast access to programs and/or data to be processed while reducing traffic on bus 2008. Storage for larger quantities of data can be provided on the local area network by one or more mass storage subsystems 2012 that can be connected to bus 2008. Mass storage subsystem 2012 can be based on magnetic, optical, semiconductor, or other data storage technologies. Direct attached storage, storage area networks, network-attached storage, and the like can be used. Any data stores or other collections of data described herein as being produced or consumed by servers can be stored in mass storage subsystem 2012. In some embodiments, additional data storage resources may be accessible via WAN interface 2010 (potentially with somewhat increased latency).

Server system 2000 can operate in response to requests received via WAN interface 2010. For example, one of modules 2002 can implement a supervisory function and assign discrete tasks to other modules 2002 in response to received requests. Conventional work allocation techniques can be used. As requests are processed, results can be returned to the requester via WAN interface 2010. Such operation can generally be automated. Further, in some embodiments, WAN interface 2010 can connect multiple server systems 2000 to each other, providing scalable solutions capable of managing high volumes of activity. Conventional or other techniques for managing server systems and server farms (collections of server systems that cooperate) can be used, including dynamic resource allocation and reallocation.

In some embodiments, operator console 2014 can be provided to allow a system operator or administrator to interact directly with server system 2000, e.g., for purposes of monitoring, testing, troubleshooting, upgrading, or the like. Operator console 2014 can include conventional computer components such as a processor 2016, storage device 2018, network interface 2020, user input device 2022, and user output device 2024. In some embodiments, operator console 2014 can be physically remote from the rest of server system 2000 and can be connected via WAN interface 2010.

Processor 2016 and storage device 2018 can be similar to processing unit(s) 2004 and local storage 2006 described above. Suitable devices can be selected based on the demands to be placed on operator console 2014; for example, console 2014 can be implemented as a “thin” client with limited processing capability. Network interface 2020 can provide a connection to bus 2008. User input device 2022 can include any device (or devices) via which a user can provide signals to console 2014; console 2014 can interpret the signals as indicative of particular user requests or information. In various embodiments, user input device 2022 can include any or all of a keyboard, touch pad, touch screen, mouse or other pointing device, scroll wheel, click wheel, dial, button, switch, keypad, microphone, and so on.

User output device 2024 can include any device via which console 2014 can provide information to a user. For example, user output device 2024 can include a display to display images generated by or delivered to console 2014. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 2024 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 2004 can provide various functionality for server system 2000, including any of the functionality described herein as being performed by a server or other functionality associated with an online content management service.

As noted above, message management service 112 and message providers 108 can interact with various client devices (e.g., client device 100) via a network (e.g., network 104) such as the Internet. Such client devices can be computing devices with network connectivity provided using wired and/or wireless technologies. Such devices can be provisioned with program code to enable various interactions with message management service 112 such as accessing stored content items, receiving push notifications, retrieving and displaying interface screens (e.g., web pages). In some embodiments, such devices can be provisioned with program code to enable some or all aspects of processes 700, 1400, 1500, and 1900.

It will be appreciated that server system 2000 is illustrative and that variations and modifications are possible. Server system 2000 can have other capabilities not specifically described here. Further, while server system 2000 is described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

While the invention has been described with respect to specific embodiments, one skilled in the art will recognize that numerous modifications are possible. For example, the particular events, data structures, servers, clients, and notification channels described herein are used for purposes of illustration; other events, data structures, servers, clients, and notification channels can be substituted.

Embodiments described above can make reference to data structures and databases or data stores. It is to be understood that these terms can encompass any techniques for organizing information into discrete records that can be stored, retrieved and interpreted by computer systems.

The various processes described herein illustrative, and it should be understood this description can encompass variations of these disclosed processes. For example, the description can encompass processes having additional steps, processes having less steps, processes having steps executed in a different order, etc. Further, processes as described herein can be implemented on any or all of a user's devices (including devices that implement different operating platforms).

Further, all of the interfaces described above and shown in the drawings are illustrative and can be modified as desired. The interfaces can be graphical user interfaces, with on-screen control elements that the user can operate, e.g., using a pointing device or touchscreen to select and activate the control elements. Other types of interfaces can also be used, including interfaces using soft keys, keystrokes, gestures, or the like. In addition, while visual interfaces are shown, it is to be understood that interfaces can also incorporate other sensory modalities, and an interface can have audio elements (e.g., voice command inputs and/or synthesized speech outputs), tactile and/or haptic elements, and so on, in addition to or instead of visual elements.

Embodiments of the present invention can be realized using any combination of dedicated components and/or programmable processors and/or other programmable devices. The various processes described herein can be implemented on the same processor or different processors in any combination, including process 232 of client devices 100, as well as processors of mailbox service layer 308 and message service layer 304 of message management system 112. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; such as memory 228 of client device 100, and mailbox service layer 308 and message service layer 304 of message management system 112; suitable media include magnetic disk or tape, optical storage media such as compact disk (CD) or DVD (digital versatile disk), flash memory, and other non-transitory media. Computer readable storage medium encoded with the program code can be packaged with a compatible electronic device, or the program code can be provided separately from electronic devices (e.g., via Internet download or as a separately packaged computer readable storage medium).

Thus, although the invention has been described with respect to specific embodiments, it will be appreciated that the invention is intended to cover all modifications and equivalents within the scope of the following claims.

What is claimed is:

1. A method comprising:
obtaining, by a device, a create-email input associated with a text message displayed by the device, the text message including a sender identifier and text-message data;
responsive to detecting the create-email input, creating, by the device, a corresponding email for the text message, wherein creating the corresponding email includes:
including at least a portion of the text-message data in a body of the corresponding email; and
including the sender identifier in at least one of the body and a header of the corresponding email; and
responsive to an instruction to reply to the corresponding email, displaying, by the device, at least one of an option to reply by text message and an option to reply by email.

2. The method of claim 1, wherein creating the email includes:
prompting, by the device, a user to input a subject to be included in the header of the corresponding email.

3. The method of claim 1, further including:
responsive to a selection of the option to reply by text message, causing a text-message application to display a reply-message window that is responsive to the text message and that includes a text-entry box to enable a user to enter a reply message to be sent to a sender of the text message.

4. The method of claim 1, further including, responsive to a selection of the option to reply by email:
accessing contact information associated with the sender identifier included in the corresponding email to identify an email address of a sender of the text message; and
causing an email application to display a reply-message window that is prepopulated with the email address of the sender of the text message and that includes a reference to the text message.

5. The method of claim 4, wherein the sender identifier and the email address are mapped in contact information stored on the device.

6. The method of claim 5, wherein the sender identifier is at least one of a phone number and a sender identifier.

7. The method of claim 1, wherein the create-email input is one of an gesture-based input, a selection of a corresponding graphical element, and a voice command.

8. The method of claim 4, wherein, in the event the contact information includes a plurality of email addresses associated with the sender of the text message, providing an option to select an email address from the plurality of email addresses.

9. The method of claim 1, wherein providing at least one of the option to reply by text and the option to reply by email includes:
providing only one of the option to reply by text and the option to reply by email if historical data indicates which of the options is likely to be selected,
wherein providing the option to reply by text includes causing a text-message application to display a reply-message window that is responsive to the text message and that includes a text-entry box to enable a user to enter a reply message to be sent to the sender of the text message,
wherein the option to reply by email includes causing an email application to display a reply-message window that is prepopulated with an email address of the sender of the text message and that includes a reference to the text message.

10. A device comprising:
a user interface;
a processor; and
a memory device including instructions that, when executed by the processor, cause the processor to, at least:
display via the user interface a text message having a sender identifier and a text-message body;
detect a create-email input associated with the text message, the create-email input being input at the user interface;
create a corresponding email having an email body and a sender field, wherein the text-message body is included in the email body and the sender field includes the sender identifier;
responsive to an instruction to reply to the corresponding email, displaying via the user interface at least one of an option to reply by text message and an option to reply by email.

11. The device of claim 10, wherein the instructions, when executed by the processor, further cause the processor to:
obtain via the user interface backfill criteria;
send the backfill criteria to a message management service;
receive from the message management service a plurality emails that satisfy the backfill criteria; and
store in a backfill data store on the device the one or more emails that satisfy the backfill criteria.

12. The device of claim 11, wherein the instructions, when executed by the processor, further cause the processor, responsive to a request to view the corresponding email, to:
identify from among the emails stored in the backfill data one or more related emails; and
group into a conversation the corresponding email and the related emails;
display via the user interface the conversation having the corresponding email and the related emails

13. The device of claim 12, wherein the one or more related emails include the sender identifier of the corresponding email.

14. The device of claim 12, wherein the one or more related emails include at least a portion of the email body of the corresponding email.

15. A method comprising:
detecting, by a device, a create-email input associated with a text message located on the device, the text message including a sender identifier and text-message data;
responsive to detecting the create-email input, prompting, by a device, a user to input a subject to be included in a corresponding email;
creating, by the device, the corresponding email by:
including the subject in a subject of the corresponding email;
including at least a portion of the text-message data in a body of the corresponding email; and
including the sender identifier in at least one of the subject, the body, and a sender field of the corresponding text message; and
causing an email app on the device to display the corresponding email in an email inbox.

16. The method of claim 15, further including:
receiving a reply-by-text instruction associated with the corresponding email displayed in the inbox;
using at least a portion of the text-message data included in the corresponding email to locate the text message on the device; and
causing a text-message application to display a reply-message window that is responsive to the text message and that includes a text-entry box to enable a user to enter a reply message to be sent to a sender of the text message.

17. The method of claim 16, wherein, in the event the contact information comprises a plurality of email addresses associated with the sender of the text message, providing an option to select an email address from the plurality of email addresses.

18. The method of claim 15, further including:
receiving a reply-by-email instruction associated with the corresponding email displayed in the inbox;
accessing contact information associated with the sender identifier included in the corresponding email to identify an email address of a sender of the text message; and
causing an email application to display a reply-message window that is prepopulated with the email address of the sender of the text message and that includes a reference to the text message.

19. The method of claim 15, further including:
responsive to an instruction to reply to the corresponding email, displaying, by the device, at least one of an option to reply by text message and an option to reply by email.

20. The method of claim 19, wherein providing at least one of the option to reply by text and the option to reply by email includes:
providing only one of the option to reply by text and the option to reply by email if historical correspondence indicates which is likely to be selected,
wherein the option to reply by text is provided by causing a text-message application to display a reply-message window that is responsive to the text message and that includes a text-entry box to enable a user to type a reply message to be sent to the sender of the text message,
wherein the option to reply by email is provided by causing an email application to display a reply-message window that is prepopulated with an email address of the sender of the text message and that includes a reference to the text message.

21. The method of claim 15, wherein the create-email input is one of an gesture-based input, a selection of a corresponding graphical element, and a voice command.

22. A computer readable storage medium having stored thereon executable instructions that, when executed by one or more processors of a computer system, cause the computer system to execute a method comprising:
selecting a text message to be archived, the text message selected based on at least on one of subject matter of text-message data included in the text message and sender information included in the text message;
sending to a message management service an archive instruction and at least a portion of the text-message data and the sender information, wherein the archive instruction causes the message management service to:
use at least a portion of the text-message data and the sender information to create a corresponding email for the text message; and
archive the corresponding email on an archive data store.

23. The computer readable storage medium of claim 22, wherein the text message is selected according to a user preference.

24. The computer readable storage medium of claim 22, wherein the method further includes:
sending backfill criteria to the message management service, the message management service applies the backfill criteria to select a plurality of emails in the archive data store that satisfy the backfill criteria;
receive from the message management service the plurality emails that satisfy the backfill criteria; and
store in a local backfill data store the one or more emails that satisfy the backfill criteria.

25. The device of claim 24, wherein the method further includes:
receiving a request to create a corresponding email that corresponds to a text message, the text message having a sender identifier and a text-message body;
identify from among the emails stored in the backfill data one or more related emails, wherein the related emails include at least one of the sender identifier and at least a portion of the text-message body; and
group the corresponding email and the related emails in a conversation.
